(19) United States
(12) Patent Application Publication
(10) Pub. No.: US 2025/0257491 A1
(43) Pub. Date: Aug. 14, 2025

(54) ELECTROCHEMICAL MEMBRANE REACTOR SYSTEMS FOR REMOVING LITHIUM FROM A LITHIUM-CONTAINING SOLUTION AND RELATED METHODS

(71) Applicant: Battelle Energy Alliance, LLC, Idaho Falls, ID (US)

(72) Inventors: Qiang Wang, Idaho Falls, ID (US); Robert V. Fox, Idaho Falls, ID (US); Daniel M. Ginosar, Idaho Falls, ID (US)

(21) Appl. No.: 19/051,983

(22) Filed: Feb. 12, 2025

Related U.S. Application Data
(60) Provisional application No. 63/552,483, filed on Feb. 12, 2024.

(51) Int. Cl. C25C 3/02; B01D 61/44; B01D 61/46; C25C 7/02; C25C 7/04; H01M 10/54

(52) U.S. Cl. CPC C25C 3/02; B01D 61/445; B01D 61/463; C25C 7/02; C25C 7/04; H01M 10/54; B01D 2313/345

(57) ABSTRACT

Systems and methods for removing lithium from a lithium-containing solution producing a lithium-enriched stream. The system includes a first electrochemical membrane reactor including one or more working electrodes, one or more counter electrodes, one or more ion exchange membranes, one or more optional bipolar membranes, and a power source configured to apply a voltage to the first electrochemical membrane reactor. A second electrochemical membrane reactor is configured to remove lithium from the lithium enriched stream. The first electrochemical membrane reactor may be coupled to the second electrochemical membrane reactor. The second electrochemical membrane reactor includes one or more working electrodes, one or more counter electrodes, one or more ion exchange membranes, and a power source configured to apply a voltage to the second electrochemical membrane reactor.

### CROSS-REFERENCE TO RELATED APPLICATION

This application claims the benefit under 35 U.S.C. § 119(e) of U.S. Provisional Patent Application Ser. No. 63/552,483, filed Feb. 12, 2024, the disclosure of which is hereby incorporated herein in its entirety by this reference.

### STATEMENT REGARDING FEDERALLY SPONSORED RESEARCH OR DEVELOPMENT

This invention was made with government support under Contract No. DE-AC07-05-ID14517 awarded by the United States Department of Energy. The government has certain rights in the invention.

### TECHNICAL FIELD

This disclosure relates generally to electrochemical membrane reactors. In particular, embodiments of the disclosure relate to an electrochemical membrane reactor systems and methods for removing lithium from a lithium-containing solution.

### BACKGROUND

Lithium is used in the production of lithium-ion batteries used in electric vehicles (EVs) and stationary storage. It is expected that global demand for lithium may increase by as much as 500% by 2050 due to widespread adoption of EVs and grid-scale battery stationary storage, and thus lithium supplies may become an even more important element in the clean energy supply chain.

Globally, commercial production of lithium is limited to sources with relatively high concentrations of lithium, like salar brines, which contain lithium salts, and from pegmatite rock sources which contain minerals like spodumene, a lithium aluminum inosilicate. Production of lithium products from salar brine sources occurs via the following general process. Brines are pumped to the surface. Then, brines are allowed to naturally evaporate in ponds until the pond reaches the appropriate lithium chloride concentration. The brine moves on to a processing plant where it goes through extraction and filtering to remove unwanted and deleterious elements and/or compounds. Then, soda ash (i.e., sodium bicarbonate) is added to precipitate out lithium carbonate which is then collected, filtered, dried, and/or converted to another lithium product (such as LiOH) to the desired specification.

Production of lithium products that may be of interest to battery manufacturers from mineral sources, like spodumene, may occur via the following general process. Spodumene may be mined and then heated (e.g., roasted) at high temperatures. The roasted product may be crushed and combined with concentrated sulfuric acid and roasted again. Then, either soda ash (i.e., sodium bicarbonate) may be added to produce a lithium carbonate or a similar procedure may be conducted that uses sodium hydroxide to instead produce LiOH. The near-final product may be crystallized, heated, filtered, and dried to produce the final product to the manufacturer's specifications.

The above processes may use large quantities of reagents, may require significant waste management, and may be energy inefficient. Salar brine evaporation in ponds may occupy a large area of land and may waste a large amount of water. Additionally, salar brine and spodumene ore has a limited geographic distribution, with more than about 98% of the total reserves concentrated in Chile, Argentina, China, and Australia.

Geothermal brines may be a potential source to satisfy U.S. lithium demand. Geothermal brines are defined as saline solutions containing dissolved materials as a result of circulating through the Earth's crust in areas of elevated temperatures. Geothermal brine sources of lithium may include closed basins, lithium clays, oilfield brines, and geothermal brines. These sources may account for about 70% to about 80% of U.S. lithium deposits. In particular, geothermal fluids in the Imperial Valley of California may represent a significant resource for lithium. The annual lithium resource potential in the Salton Sea region of California is estimated at 600,000 tons (t) of lithium carbonate, which currently exceeds the annual U.S. demand for lithium and may transform the U.S. from a net lithium importer to a net exporter.

However, there are few pilot-scale plants which can economically and environmentally sustainably extract Li from the brine. Brine has a very high concentration of chloride, sodium, and potassium, and the lithium concentration in brine is not very high at from about 100 ppm to about 200 ppm.

Currently available methods for extracting lithium from geothermal brine include adsorption, ion exchange, solvent extraction, electrodialysis, and chemical precipitation. One reported method includes a 17 step process including silicon (Si) and iron (Fe) removal using three chemical precipitation steps, manganese (Mn) and zinc (Zn) removal by solvent extraction with CYANEX® 272 (a dialkyl phosphinic acid extractant), lithium (Li) extraction using aluminum (Al) based ion exchange sorbent, calcium (Ca) and magnesium (Mg) removal by ion exchange, and lithium chloride (LiCl) purification by chemical precipitation and solvent extraction. These multiple steps are followed by LiCl conversion to lithium hydroxide (LiOH) by electrolysis. However, the process may be environmentally and economically unsustainable for at least the reasons that the Al based sorbent may have a low lithium recovery efficiency (about 60%), low stability, and low capacity (less than about 8 mg/g). The sorbent comprising manganese oxide (MnO₂) particles may exhibit a high lithium adsorption capacity (24 mg/g), but may require acid for sorbent regeneration, which may cause dissolution of Mn³⁺ ions and degradation of the sorbent. The sorbent may have a lithium/sodium selectivity ratio of about 50 and a lithium/potassium selectivity ratio of greater than about 200. Because of the high concentration of sodium (Na) and Mg in brine, the selectivity may not be large enough to extract lithium with high purity from brine. Organic extractant may have a high cost and negative environmental impact. Current electrodialysis technology, which may employ electrode materials from lithium-ion (Li-ion) batteries, such as lithium manganese dioxide (LiMnO₂), lithium iron phosphate (LiFePO₄), lithium metatitanate (Li₂TiO₃), graphite and lithium nickel manganese cobalt oxides (LiNiₓMn_{y}Co_{z}O₂) (x+y+z=1), to extract lithium from brine, seawater or other lithium-containing solution, may be in a low technology readiness level, because they may exhibit one or more of low lithium recovery efficiency, low lithium processing rate, low lithium selectivity, and low durability.

### BRIEF SUMMARY

Disclosed is a system comprising a first electrochemical membrane reactor configured to process a solution comprising lithium and one or more elements. The first electrochemical membrane reactor is configured to remove at least one of the one or more elements and to form a lithium enriched stream. The first electrochemical membrane reactor comprises one or more working electrodes in a first chamber, one or more anion exchange membranes in the first chamber, one or more cation exchange membranes in a second chamber between one of the one or more anion exchange membranes and one of the one more cation exchange membranes. A third chamber is between one of the one or more one more cation exchange membranes and a reactor wall. One or more counter electrodes are in the third chamber. An inlet for introducing one or more of nitrogen, argon, air, and oxygen into the solution and a power source configured to apply a voltage to the first electrochemical membrane reactor. A second electrochemical membrane reactor is configured to remove lithium from the lithium enriched stream. The first electrochemical membrane reactor is coupled to the second electrochemical membrane reactor. The second electrochemical membrane reactor comprise one or more working electrodes, one or more counter electrodes, one or more bipolar membranes, and a power source configured to apply a voltage to the second electrochemical membrane reactor.

Also disclosed is a system comprising a first electrochemical membrane reactor configured to process a solution comprising lithium and one or more elements. The first electrochemical membrane reactor is configured to remove at least one of the one or more elements and to form a lithium enriched stream. The first electrochemical membrane reactor comprises one or more working electrodes in a first chamber, one or more anion exchange membranes in the first chamber, one or more bipolar membranes in a second chamber, the second chamber between one of the one or more anion exchange membranes and one of the one or more bipolar membranes; a third chamber between one of the one or more bipolar membranes and a reactor wall; one or more counter electrodes in the third chamber; an inlet for introducing one or more of nitrogen, argon, air, and oxygen into the solution comprising lithium and one or more elements; and a power source configured to apply a voltage to the first electrochemical membrane reactor. A second electrochemical membrane reactor is configured to remove lithium from the lithium enriched stream. The first electrochemical membrane reactor is coupled to the second electrochemical membrane reactor. The second electrochemical membrane reactor comprises one or more working electrodes, one or more counter electrodes, one or more bipolar membranes, and a power source configured to apply a voltage to the second electrochemical membrane reactor.

Also disclosed is a system comprising an electrochemical membrane reactor comprising one or more counter electrodes in one or more counter electrode chambers, one or more working electrodes in one or more working electrode chambers adjacent the one or more counter electrode chambers, and at least one ionic exchange membrane between at least one of the one or more counter electrode chambers and the one or more working electrode chambers. An inlet for supplying a leaching solution to the one or more working electrodes chambers. A power source is electrically coupled to the one or more counter electrodes and the one or more working electrodes for applying a current between the one or more counter electrodes and the one or more working electrodes. A purging system for introducing one or more of N₂, argon, air, and O₂ is coupled to the electrochemical membrane reactor. A pH measurement system is coupled to the electrochemical membrane reactor. An outlet for discharging a purified leaching solution.

Also disclosed is a method for recovering lithium from a lithium-containing solution comprising introducing a solution comprising lithium and one or more elements to a first electrochemical membrane reactor and applying a voltage to the first electrochemical membrane reactor to ionize one or more of the one or more elements to reduce the one or more ionized elements to form one or more reduced elements. A pH of the solution is adjusted to precipitate the one or more reduced elements and the one or more precipitated elements are removed from the solution comprising lithium and one or more elements to form a lithium enriched stream. The lithium enriched stream is introduced to a second electrochemical membrane reactor and one or more of battery material, MnO₂, graphite, FePO₄, Li₂₋ₓTiO₃, Li_{1-x′}NiₓMn_{y}CO_{z}O₂ in the lithium enriched stream and suspended to form a first suspension. One or more of lithiated MnO₂, graphite, FePO₄, Li_{2-x′}TiO₃, Li_{1-x′}NiₓMn_{y}CO_{z}O₂ (x+y+z=1) particles in a LiOH solution are suspended to form a second suspension. The first suspension and the second suspension are subjected to one or more of mechanical stirring, Vortex shaking, or ultrasound. The first suspension is passed through a working electrode chamber of a second electrochemical membrane reactor. The second suspension is passed through one or more counter electrode chambers of the second electrochemical membrane reactor. A voltage is applied to the second electrochemical membrane reactor to extract lithium from the first suspension forming a lithium depleted stream, releasing lithium into a LiOH solution forming a concentrated LiOH solution. Lithium is recovered from the concentrated LiOH solution forming a residual stream of LiOH that is substantially free of lithium.

### BRIEF DESCRIPTION OF THE DRAWINGS

For a detailed understanding of the disclosure, reference should be made to the following detailed description, taken in conjunction with the accompanying drawings, in which like elements have generally been designated with like numerals, and wherein:

FIG. 1A is a side view of an electrochemical membrane reactor I (first EMR), in accordance with embodiments of the disclosure.

FIG. 1B is a side view of an electrochemical membrane reactor I (first EMR), in accordance with other embodiments of the disclosure.

FIG. 1C is a side view of an electrochemical membrane reactor I (first EMR), in accordance with other embodiments of the disclosure.

FIG. 1D is a top-down view of the electrochemical membrane reactor I (first EMR) of FIG. 1A.

FIG. 1E is a top-down view of the electrochemical membrane reactor I (first EMR) of FIG. 1B.

FIG. 1F is a three-dimensional view of an electrochemical membrane reactor (first EMR) in accordance with embodiments of the disclosure.

FIG. 2A is a side view of a second electrochemical membrane reactor (second EMR), in accordance with embodiments of the disclosure.

FIG. 2B is a side view of a second electrochemical membrane reactor (second EMR), in accordance with embodiments of the disclosure.

FIG. 3A is an image of a metal frame porous electrode (MFPE) showing MnO₂ or LiMn₂O₄ nanoparticles in suspension flowing through the metal frame, in accordance with embodiments of the disclosure.

FIG. 3B is an image of a side view of a prior art paste electrode having MnO₂ or LiMn₂O₄ particles thereon.

FIG. 3C is an image of a view of a prior art three-dimensional flow-through electrode.

FIG. 4 is a schematic flow diagram describing a method of separating elements and removing (e.g., extracting) lithium from a lithium-containing solution (e.g., brine), in accordance with embodiments of the disclosure.

FIG. 5 is a graph showing the pH increase of the electrolytes with the applied current as a function of electrolysis time for the first EMR.

FIG. 6 is an illustration of a carbon network having electrical conductivity for Fe₂O₃ particle reduction, in accordance with embodiments of the disclosure.

FIG. 7 is an X-ray Diffraction Analysis (XRD) of a product prepared in accordance with embodiments of the disclosure.

### DETAILED DESCRIPTION

The illustrations presented herein are not actual views of any electrochemical membrane reactor system, or any component thereof, but are merely idealized representations, which are employed to describe embodiments of the present invention.

As used herein, the singular forms following “a,” “an,” and “the” are intended to include the plural forms as well, unless the context clearly indicates otherwise.

As used herein, the term “may” with respect to a material, structure, feature, or method act indicates that such is contemplated for use in implementation of an embodiment of the disclosure, and such term is used in preference to the more restrictive term “is” so as to avoid any implication that other compatible materials, structures, features, and methods usable in combination therewith should or must be excluded.

As used herein, any relational term, such as “first,” “second,” “top,” “bottom,” “upper,” “lower,” “above,” “beneath,” “side,” “upward,” “downward,” etc., is used for clarity and convenience in understanding the disclosure and accompanying drawings, and does not connote or depend on any specific preference or order, except where the context clearly indicates otherwise. For example, these terms may refer to an orientation of elements of any electrochemical reactor when utilized in a conventional manner. Furthermore, these terms may refer to an orientation of elements of any electrochemical membrane reactor as illustrated in the drawings.

As used herein, the term “substantially” in reference to a given parameter, property, or condition means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0% met, at least 95.0% met, at least 99.0% met, or even at least 99.9% met.

As used herein, the term “about” used in reference to a given parameter is inclusive of the stated value and has the meaning dictated by the context (e.g., it includes the degree of error associated with measurement of the given parameter, as well as variations resulting from manufacturing tolerances, etc.).

As used herein, the terms “comprising,” “including,” “containing,” “characterized by,” and grammatical equivalents thereof are inclusive or open-ended terms that do not exclude additional, unrecited elements or method acts, but also include the more restrictive terms “consisting of” and “consisting essentially of” and grammatical equivalents thereof. The term “containing,” as used to describe embodiments herein, is not meant to be exclusive. For example, a lithium-containing solution may include additional chemical elements or chemical compounds.

Systems and methods including a flowing electrochemical membrane reactor (EMR) are described. In the flowing EMR, a liquid (e.g., a solution) is passed (e.g., pumped) through the reactor, and reactions occur as the solution flows past an electrode of the EMR. The systems and methods may be utilized to remove (e.g., extract electrochemically) lithium from a lithium-containing solution. The lithium-containing solution may include one or more of brine, seawater, oil and gas produced water (e.g., water that is extracted from the ground during the process of oil- and gas-production), a leachate of spent lithium ion batteries (e.g., a liquid solution created when valuable metals such as lithium, cobalt, nickel, and manganese are extracted from a cathode material of used lithium-ion batteries through a chemical process called “leaching,” where the metals dissolve in a solvent, typically an acidic solution, leaving behind the remaining non-dissolved components), a leachate of mining (e.g., a liquid that comes from water passing through waste materials from mining), a leachate of mine tailings (e.g., mine tailings being a leftover material from the process of extracting minerals from the earth), and wastewater, which are collectively referred to herein as a lithium-containing solution. In embodiments of the disclosure, the lithium-containing solution may include lithium at from about 10 ppm to about 1,000 ppm, or from about 10 ppm to about 200 ppm, or from about 100 ppm to about 200 ppm. Alternatively, the lithium-containing solution may include a greater concentration of lithium. The systems and methods may provide advantages such as one or more of a high lithium selectivity, a high lithium recovery (e.g., extraction) efficiency, and a high durability for cycling (e.g., long cyclability) compared to conventional electrodialysis methods. The lithium may be recovered in a lithium enriched stream. While embodiments described herein may refer to recovering lithium from brine, other lithium-containing solutions may be processed similarly.

The electrochemical membrane reactor systems and methods may use a small amount of reagents (e.g., chemicals), may avoid the degradation mechanism of MnO₂ particles that may occur with Al based ion exchange sorbent methods, and may accurately and precisely enable control of the electrode potential to extract the lithium without also extracting sodium and potassium from the lithium-containing solution. The electrochemical membrane reactor systems and methods may overcome the limit of lithium ion diffusion in the liquid and may mitigate or overcome reactor mechanical and thermal instability.

In embodiments of the disclosure, the electrochemical membrane reactor (EMR) systems and methods may include two electrochemical membrane reactors (EMRs, such as a first EMR and a second EMR). The first EMR and the second EMR may be coupled (e.g., connected) by a conduit suitable for flowing a lithium enriched stream, which is produced in the first EMR, to the second EMR. Alternatively, the lithium enriched stream produced in the first EMR may be contained in a vessel and subsequently introduced (e.g., poured) into the second EMR. The EMR systems and methods according to embodiments of the disclosure may be utilized to lower the amounts of desired chemical elements in the lithium-containing solution (e.g., a solution comprising lithium and one or more of the elements). The first EMR may be configured to reduce the amounts of certain elements in the lithium-containing solution, such as one or more of chloride, silver, cadmium, aluminum, iron, manganese, copper, gallium, chromium, zirconium, ruthenium, magnesium, lead, antimony, tin, platinum, gold, cobalt, nickel, magnesium, zinc, and rare earth elements (Cl, Ag, Cd, Al, Fe, Mg, Cu, Ga, Cr, Zr, Ru, Mg, Pb, Sb, Sn, Pt, Au, Co, Ni, Mg, Zn, and rare earth elements (REEs), respectively). The rare earth elements may include one or more of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y). The rare earth elements may include one or more of lanthanum (La), cerium (Ce), praseodymium (Pr), neodymium (Nd), promethium (Pm), samarium (Sm), europium (Eu), gadolinium (Gd), terbium (Tb), dysprosium (Dy), holmium (Ho), erbium (Er), thulium (Tm), ytterbium (Yb), lutetium (Lu), scandium (Sc), and yttrium (Y). The lithium-containing solution may also include chlorine (Cl). In embodiments of the disclosure, the EMR systems and methods may reduce the amount of these elements to concentrations of less than or equal to about 1 ppm while increasing a concentration or weight percentage of Li for recovery in a concentrated Li stream (also referred to herein as the lithium enriched stream). Lowering the concentrations of these elements may eliminate the interference of their ions on subsequent Li extraction. The first EMR may be configured to remove chlorine (Cl) (e.g., Cl ions or Cl-containing compounds) from the lithium-containing solution to generate byproducts such as sulfuric acid (H₂SO₄) with NaCl or HCl. The first EMR may also be configured to generate byproducts such as metal, metal oxide compounds including, but not limited to, one or more of Cu, Ni, Zn, Co, Pb, Al(OH)₃, Fe(OH)₃, REEs(OH)₃, Mn(OH)₂, MnO₂, and Mg(OH)₂. In embodiments of the disclosure, the first EMR may be configured to generate Mn(OH)₂, MnO₂, and Mg(OH)₂ byproducts having a purity of greater than about 95% by weight. By comparison with conventional technologies, which may conduct several acts including chemical precipitation, solvent extraction, and ion exchange to extract similar elements, and that may introduce impurities into the liquid during the process, using the first EMR may remove impurities and concentrate lithium to produce the lithium enriched stream in a single process and consume only electricity, air, and water, while introducing few reagents or zero extra reagents or impurities into the lithium-containing solution.

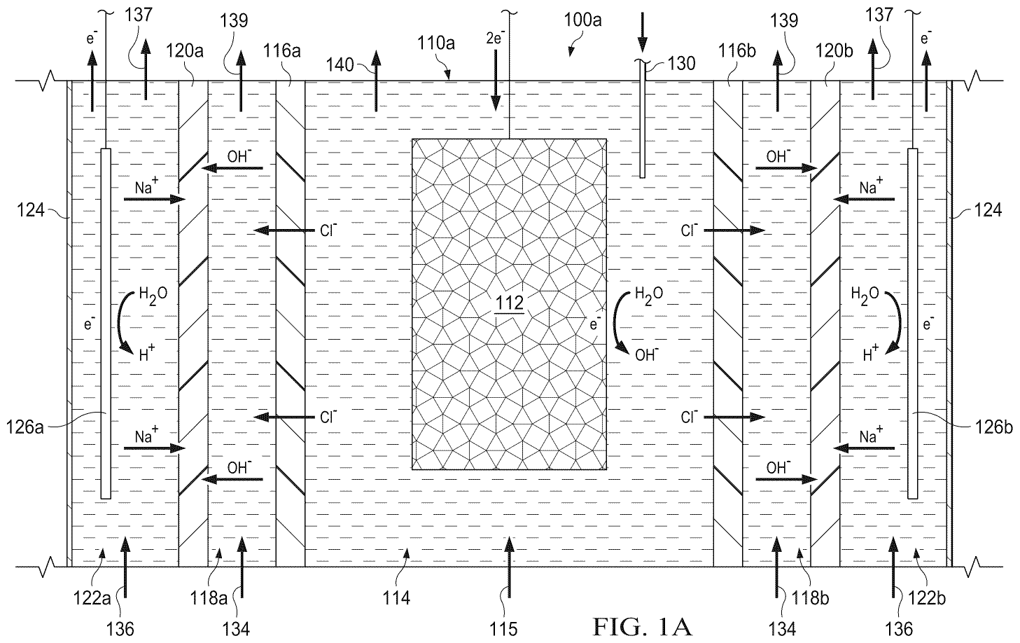

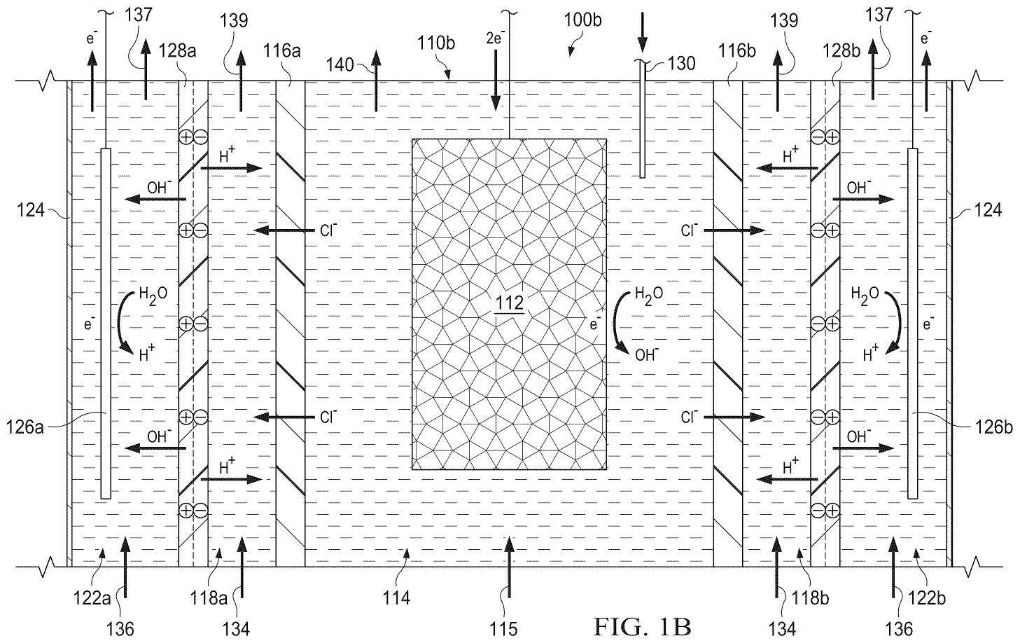

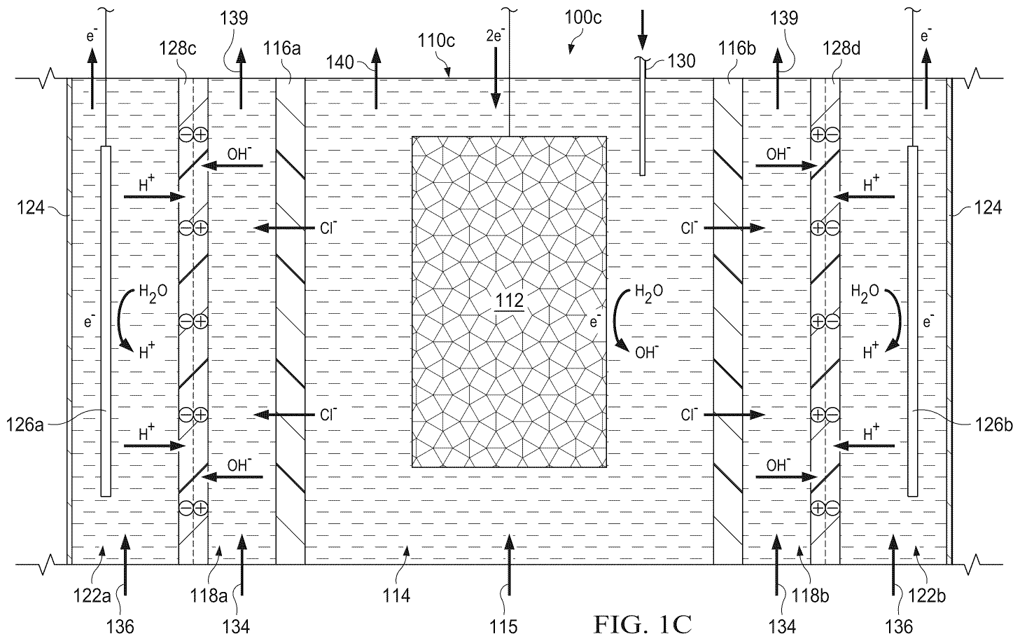

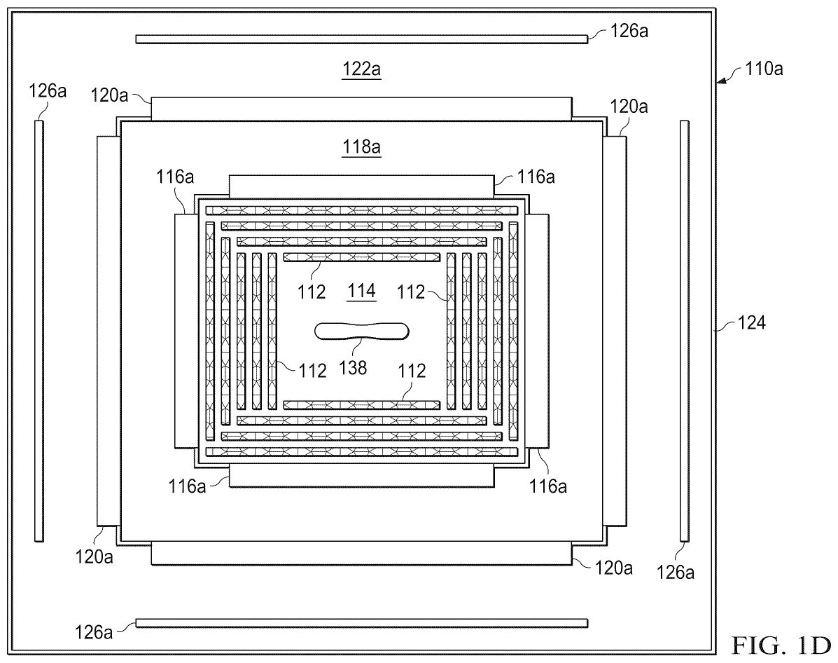

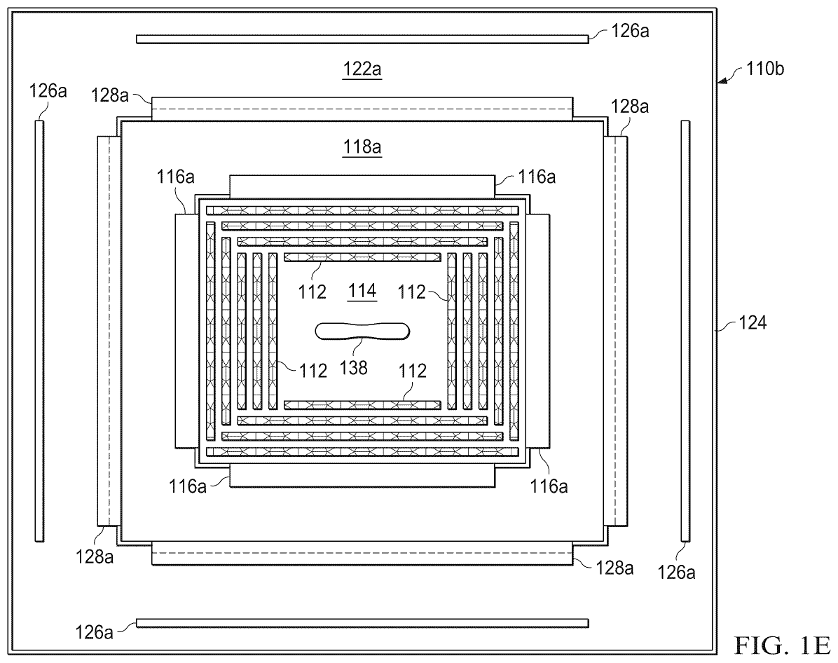

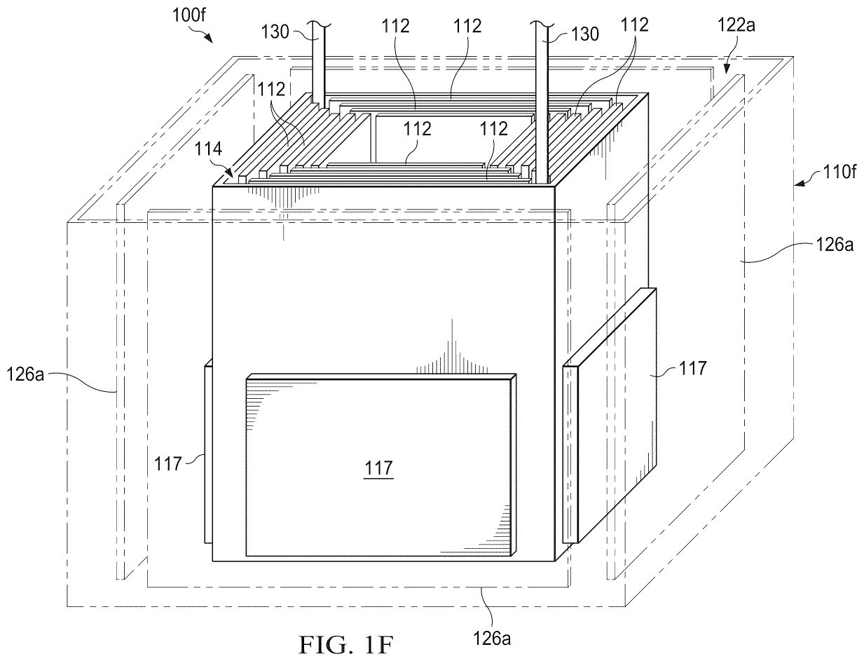

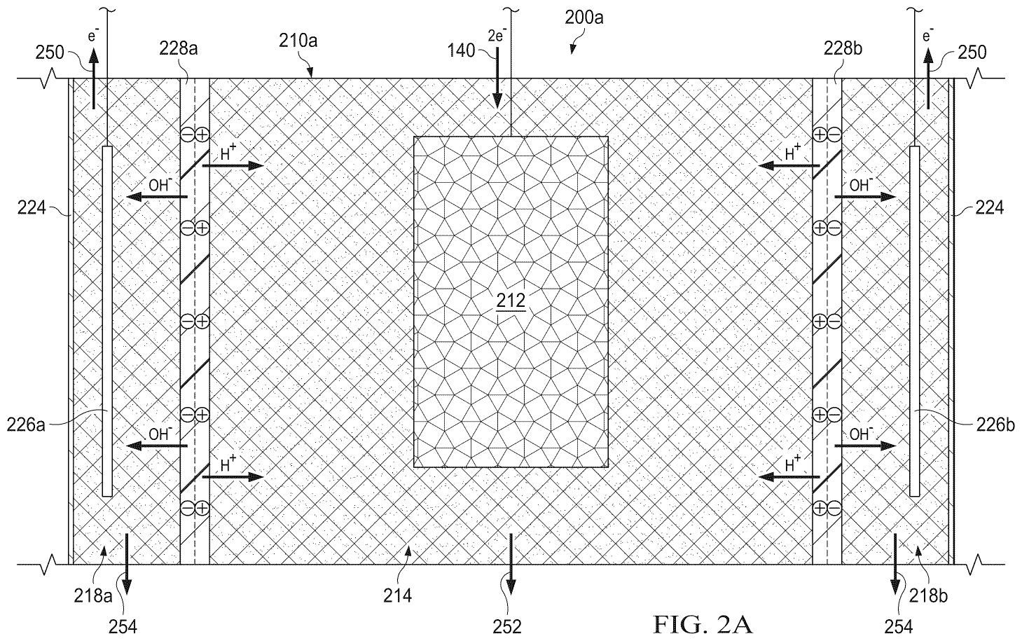

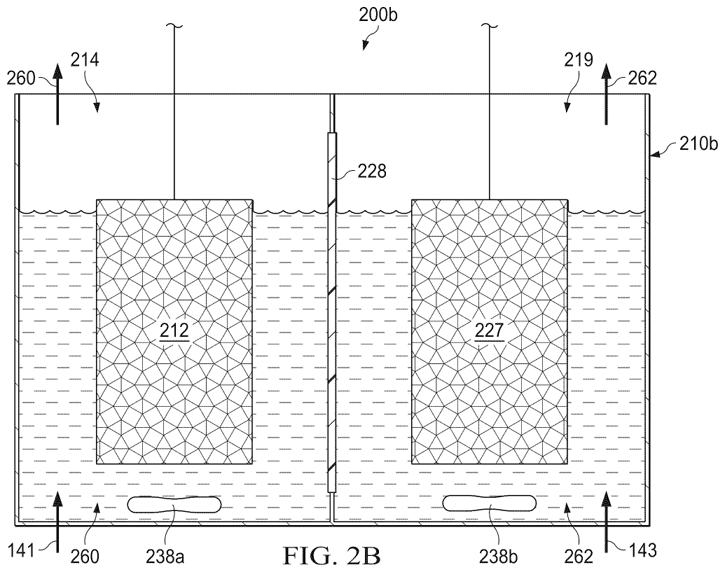

The systems and methods may include recovering lithium from the lithium-containing solution in the first electrochemical membrane reactor to form the lithium enriched stream. The lithium enriched stream may be processed in the second electrochemical membrane reactor to remove (e.g., extract) lithium from the lithium enriched stream. Embodiments of the first electrochemical membrane reactor are shown in FIG. 1A, FIG. 1B, FIG. 1C, FIG. 1D, FIG. 1E, and FIG. 1F, and embodiments of the second electrochemical membrane reactor are shown FIG. 2A and FIG. 2B. The first and second electrochemical membrane reactors may include electrodes (e.g., anodes, cathodes), chambers, membranes, and a power supply.

As shown in FIG. 1A, FIG. 1B, FIG. 1C, FIG. 1D, FIG. 1E, and FIG. 1F, a first electrochemical membrane reactor includes one or more of one or more plate electrodes and one or more Metal Frame Porous Electrode(s) (MFPEs). The first electrochemical membrane reactor may include a Metal Frame Porous Electrode (e.g., a Metal Frame Porous Working Electrode, e.g., a Metal Frame Porous Cathode (MFPC)) in a middle chamber and two or more counter electrodes (e.g., anodes) surrounding the working electrode (e.g., cathode). The cathode and anodes may be separated by one or more of one or more bipolar membranes (BPM), one or more cationic exchange membranes (CEM), and one or more anionic exchange membranes (AEM). The first electrochemical membrane reactor may include one or more anion exchange membranes (AEM) between (e.g., sandwiched between) a first chamber and a second chamber, and one or more cation exchange membranes (CEM), or one or more Bipolar Membranes (BPM), between (e.g., sandwiched between) a second chamber and a third chamber. The anionic exchange membrane (AEM), cation exchange membrane (CEM), and bipolar membrane (BPM) may include polymer backbones with one or more of cationic functional groups and anionic functional groups bonded on the backbone. Examples of polymer backbones include, but are not limited to, poly(phenylene), poly(ethylene), poly(arylene ether sulfone), among others. Cationic functional groups include, but are not limited to, ammonium, imidazolium, pyridinium, among others. Anionic groups include, but are not limited to, sulfonic acid, phosphonic acid, carboxyl, among others. Different kinds of AEMs, CEMs, and BPMs may be selected depending on their ionic conductivity, cation, anion blocking properties, and durability.

The working electrode (e.g., cathode) may comprise one or more of a plate electrode and a metal frame porous electrode. The working electrode (e.g., cathode) may be selected and configured so as to not introduce extra impurities into the lithium-containing solution. The working electrode (e.g., cathode) material may be selected from, but is not limited to, one or more of lead, bismuth, nickel, copper, steel, carbon, and titanium. The metal frame porous electrode may desirably be easily operated and washable. The metal frame porous electrode may be selected from one or more of porous metal, foam, and mesh, although not limited thereto. Electrode materials may be selected depending on factors including, but not limited to, the potential distribution on the MFPE, electrode pore density, electrochemical reactions, and their rate. An electrode with an optimized pore density may be selected to process the lithium-containing solution at a fast rate through the first EMR. In embodiments of the disclosure, the plate working electrode comprises a material formulated to suppress a hydrogen gas evolution reaction. For example, the plate working electrode may comprise one or more of lead, bismuth, and titanium. The porous working electrode may comprise a chemically resistant material. For example, the porous working electrode may comprise one or more of stainless steel, titanium, nickel alloy, carbon, and copper. The porous working electrode may exhibit a coating on a surface of the porous working electrode, the coating comprising carbon nanoparticles bonded to the surface of the porous working electrode by one or more of polyvinylidene fluoride, polytetrafluoroethylene, sulfonated tetrafluoroethylene-based fluoropolymer copolymer, cation exchange ionomers, and anion exchange ionomers.

The counter electrode (e.g., anode) may comprise an inert metal, such as one or more of titanium, titanium coated with iridium oxide, titanium coated ruthenium oxide, platinum, gold, carbon, and silver, although not limited. The counter electrode (e.g., anode) may comprise an active metal, such as one or more of lead, nickel, iron, and copper, although not limited. In embodiments of the disclosure, a material of the counter electrode (e.g., anode) may be selected in accordance with factors including the maximum current density the electrodes supply and the oxidation reaction happening on the electrode surface. The dimension and arrangement of the counter electrodes may be selected depending on the configuration of the reactor(s). The configuration of the reactor(s) may be arranged to maximize the electrode/electrolyte interface of the working electrode, and with consideration of the extraction sequence of the elements.

The electrode potential distribution on the MFPE may be controlled to enable extraction of Li⁺ ions without extracting Mg²⁺, Na⁺, K⁺ ions and other ions. Cyclic voltammetry and chronopotentiometry tests may be performed on MFPE, and the potential distribution may be measured by using a three-electrode system. Applied current, pore density of MFPE and its potential distribution, may be controlled by selecting the foam thickness, pore density, current value, among other properties.

The lithium enriched stream produced by the first electrochemical membrane reactor may be transferred to the second electrochemical membrane reactor to remove (e.g., extract) lithium from the lithium enriched stream. The second electrochemical membrane reactor may directly remove (e.g., extract) the lithium from the lithium enriched stream formed in the first electrochemical membrane reactor to form a lithium hydroxide (LiOH) solution through an intercalation/deintercalation reaction, with exemplary reactions shown in equations (1) and (2).

2λ-MnO₂+Li⁺+e⁻→LiMn₂O₄ (1)

LiMn₂O₄→2λ-MnO₂+Li⁺+e⁻ (2)

The LiOH solution may include one or more of the lithium ion battery materials, such as MnO₂ particles and LiMn₂O₄ particles. The lithium may be recovered from the LiOH solution and a residual stream that is substantially free of lithium may be produced.

The second EMR may be configured to extract the lithium by selecting the arrangement of the MFPEs (e.g., MFPC, MFPA) and BPM(s), the thickness of the metal foams, their pore density, the length of the foam, the flowing rate and direction of the suspension, and the placement of the reactor. When the suspension flows through the second EMR, desirably all or substantially all of the particles of lithium ion battery material, such as MnO₂ and LiMn₂O₄ particles, may be involved in the intercalation and deintercalation completely. The particles desirably do not aggregate and not block the pore inside the foam. These factors may optimize the flow rate of the suspension. Agitation (e.g., stirring, Vortex shaking, ultrasound) may be introduced to the reactor to minimize or prevent nanoparticles from aggregation.

As shown in FIG. 1A, a system 100a including first electrochemical membrane reactor 110a may comprise a porous working electrode 112 (e.g., a porous cathode) in a first chamber 114. In operation, a lithium-containing solution 115 (e.g., a solution comprising lithium and one or more elements) is introduced into the first chamber 114. For example, the lithium-containing solution 115 may be poured into first chamber 114 or introduced through a solution inlet (e.g., tubing, not shown). A first anion exchange membrane 116a is between the first chamber 114 and a second chamber 118a and a second anion exchange membrane 116b is between the first chamber 114 and second chamber 118b. One or more additional anion exchange membranes (not shown) may optionally be disposed on other sides between the first chamber 114 and second chambers 118a, 118b. First electrochemical membrane reactor 110a may include a first cation exchange membrane 120a, a second cation exchange membrane 120b, and optionally one or more additional cation exchange membranes (not shown). The second chamber 118a and second chamber 118b are between anion exchange membranes 116a, 116b and cation exchange membranes 120a, 120b. A third chamber 122a (e.g., anode chamber) and third chamber 122b are between cation exchange membranes 120a, 120b and the reactor wall 124. Counter electrode 126a (e.g., anode) and counter electrode 126b are in the third chamber 122a and third chamber 122b, respectively. One or more additional chambers (not shown) may optionally be between additional anion exchange membranes and additional cation exchange membranes and between additional cation exchange membranes and the reactor wall 124. An inlet 130 (e.g., tubing) for introducing one or more of nitrogen, argon, air, and oxygen into the lithium-containing solution 115 (e.g., a solution comprising lithium and one or more elements) is connected to the first chamber 114. FIG. 1D is a top-down view of the first electrochemical membrane reactor 110a shown in FIG. 1A. A mechanical stirrer 138 (shown in FIG. 1D and FIG. 1E) may be included in the system 100a, such as in first chamber 114.

As shown in FIG. 1B, a system 100b including first electrochemical membrane reactor 110b may comprise a porous working electrode 112 (e.g., porous cathode) in a first chamber 114. A first anion exchange membrane 116a may be on one side between the first chamber 114 and second chamber 118a and a second anion exchange membrane 116b may be on an opposite side between the first chamber 114 and second chamber 118b. One or more additional anion exchange membranes (not shown) may optionally be disposed on other sides between the first chamber 114 and second chambers 118a, 118b. First electrochemical membrane reactor 110b may include a first bipolar membrane 128a, a second bipolar membrane 128b, and, optionally, one or more additional bipolar membranes (not shown). Second chambers 118a, 118b are between anion exchange membranes 116a, 116b and bipolar membranes 128a, 128b. One or more additional chambers (not shown) may optionally be between additional anion exchange membranes and additional bipolar membranes. A third chamber 122a is between the bipolar membrane 128a and the reactor wall 124 and a third chamber 122b is between bipolar membrane 128b and reactor wall 124. First chamber 114, second chambers 118a, 118b, and third chambers 122a, 122b may be connected together (connections not shown). First electrochemical membrane reactor 110b may include a first counter electrode 126a (e.g., anode), a second counter electrode 126b (e.g., anode), and, optionally, one or more additional counter electrodes (not shown). One or more additional chambers (not shown) may be between additional anion exchange membranes and additional bipolar membranes and between additional bipolar membranes and reactor wall 124. An inlet 130 (e.g., tubing) for introducing one or more of nitrogen, argon, air, and oxygen into the lithium-containing solution 115 (e.g., a solution comprising lithium and one or more elements) is connected to first chamber 114. FIG. 1E is a top view of first electrochemical membrane reactor 110b shown in FIG. 1B. A mechanical stirrer 138 (shown in FIG. 1D and FIG. 1E) may be included in the system 100b, such as in first chamber 114. FIG. 1F is a three-dimensional view of a first electrochemical membrane reactor including working electrode (e.g., cathode) 112, first chamber 114 (e.g., cathode chamber), ionic exchange membrane 117, inlet 130 (e.g., for nitrogen, air, oxygen purge), counter electrode (e.g., anode) 126a, second chamber 122a (e.g., anode chamber), and mechanical stirrer 138.

As shown in FIG. 1C, a system 100c including first electrochemical membrane reactor 110c may comprise a porous working electrode 112 (e.g., porous cathode) in a first chamber 114. A first anion exchange membrane 116a is between the first chamber 114 and second chamber 118a and a second anion exchange membrane 116b is between the first chamber 114 and second chamber 118b. One or more additional anion exchange membranes (not shown) may be on other sides between the first chamber 114 and second chamber 118a and second chamber 118b. A first bipolar membrane 128c is between second chamber 118a and third chamber 122a. A second bipolar membrane 128d is between second chamber 118b and third chamber 122b. The first bipolar membrane 128c and second bipolar membrane 128d may be in an opposite orientation from the first bipolar membrane 128a and second bipolar membrane 128b in the first electrochemical membrane reactor 110b of FIG. 1B. Second chambers 118a, 118b are between anion exchange membranes 116a, 116b and bipolar membranes 128c, 128d. One or more additional chambers (not shown) may optionally be between additional anion exchange membranes and additional bipolar membranes. Third chamber 122a is between bipolar membrane 128c and the reactor wall 124. Third chamber 122b is between the bipolar membrane 128d and reactor wall 124. Chambers 118a may connect with chamber 118b (connections not shown). Chamber 122a may connect with chamber 122b (connections not shown). First electrochemical membrane reactor 110c may include a first counter electrode 126a (e.g., anode), a second counter electrode 126b (e.g., anode), and, optionally, one or more additional counter electrodes (e.g., anodes) (not shown). One or more additional chambers (not shown) may optionally be between additional anion exchange membranes and additional bipolar membranes and between additional bipolar membranes and the reactor wall 124. An inlet 130 (e.g., tubing) for introducing one or more of nitrogen, argon, air, and oxygen into a solution (e.g., a solution comprising lithium and one or more elements, the lithium-containing solution) is connected to first chamber 114.

As shown in FIG. 1F, a system 100f including first electrochemical membrane reactor 110f may comprise a plate working electrode or a porous working electrode 112 (e.g., porous cathode) in a first chamber 114. An anionic exchange membrane 117 is between the first chamber 114 and second chamber 122a and a second anion exchange membrane 117 is between the first chamber 114 and second chamber 122a. One or more additional anionic exchange membranes (not shown) may be on other sides between the first chamber 114 and second chamber 122a. Second chambers 122a are between anion exchange membranes 117 and the reactor wall of the first electrochemical reactor. One or more additional chambers (not shown) may optionally be between additional anion exchange membranes and reactor wall.

Chambers 122a may connect with chamber 122a (connections not shown). First electrochemical membrane reactor 110f may include a first counter electrode 126a (e.g., anode), a second counter electrode 126b (e.g., anode), and, optionally, one or more additional counter electrodes (e.g., anodes) (not shown). An inlet 130 (e.g., tubing) for introducing one or more of nitrogen, argon, air, and oxygen into a solution (e.g., a solution comprising lithium and one or more elements, the lithium-containing solution) is connected to first chamber 114.

Turning to FIGS. 2A and 2B, systems 200a, 200b include a second electrochemical membrane reactor 210a, 210b. The system 200a or system 200b may be in fluid communication with one or more of the systems 100a, 100b, 100c, 100f. The electrochemical membrane reactor 210a may include a Metal Frame Porous Working Electrode 212 (e.g., a Metal Frame Porous Cathode (MFPC)) in a first (e.g., middle) chamber 214 and two or more Metal Frame Porous Counter Electrodes 226a, 226b (e.g., Metal Frame Porous Anodes (MFPAs)) on both sides of, or surrounding, the cathode 212. The cathode 212 and anodes 226a, 226b may be separated by bipolar membranes 228a, 228b. The second electrochemical membrane reactor 210a may comprise the porous cathode 212 in first chamber 214 (e.g., cathode chamber). The second electrochemical membrane reactor 210a may comprise the one or more bipolar membranes 228a, 228b on one or more sides of the first chamber 214. In embodiments of the disclosure, the second electrochemical membrane reactor 210a may comprise first bipolar membrane 228a on one side of the first chamber 214 and second bipolar membrane 228b on an opposite side of the first chamber 214 and, optionally, one or more additional bipolar membranes (not shown) on other sides of the chamber 214. A second chamber 218a may be between the first bipolar membrane 228a and a reactor wall 224. A second chamber 218b may be between the second bipolar membrane 228b and reactor wall 224. Second chambers 218a, 218b, and any other additional chambers, may be connected together. One or more additional porous cathodes and anodes may be included in one or more additional chambers. The porous cathodes and anodes may have pores in a size range of from a micrometer to millimeters. The porous cathode may contain a suspension comprising particles from lithium-ion batteries, such as MnO₂ particles, suspended inside a lithium-ion containing solution, such as brine. The porous anode chamber may contain a suspension comprising particles such as lithiated lithium-ion battery material, suspended inside a diluted lithium hydroxide solution.

Thus, in embodiments of the disclosure, a flowing EMR system including the first EMR (e.g., 100a, 100b, 100c, 100f) and the second EMR (e.g., 210a, 210b) and a process is described that may efficiently extract about 95% of lithium from lithium-containing solutions, such as geothermal brine, leachates of mines, and leachates of spent lithium ion batteries, without consuming chemicals and while also generating valuable by-products, including one or more of Cu, Ni, Co, Pb, Zn, Ag, Pt, Au, U(OH)₄, Th(OH)₄, Ga(OH)₃, Cr(OH)₃, Al(OH)₃, Fe(OH)₃, Zr(OH)₄, Cd(OH)₃, REEs(OH)₃, Mg(OH)₂, Mn(OH)₂, NaCl, H₂SO₄, or HCl. With a purity of greater than or equal to about 99%, the extracted LiOH may be used as battery grade LiOH with a relatively low amount of additional handling. The whole process may involve a smaller chemical footprint than any conventional Li extraction technologies. An electrolysis protocol that sequentially removes the elements may be designed for the elements' extraction. By using the protocol, the processing time may be shortened over processing times of conventional techniques. By way of example only, Ag, Cu, Cd, Fe, Al, Zn, Pb, Co, Ni, Ga, Zr, REEs, Mn and Mg may be effectively extracted to less than about 1 ppm, and Mn(OH)₂ and Mg(OH)₂ purity may be greater than about 95%.

In embodiments of the disclosure, methods for recovering lithium from the lithium-containing solution 115 comprising lithium and one or more elements may comprise introducing the lithium-containing solution 115 to the first electrochemical membrane reactor. A voltage may be applied across the electrodes of the first electrochemical membrane reactor to ionize (e.g., reduce or oxidize) the one or more elements. By way of example only, a voltage of from about 2.0 V to about 3.5 V may be applied. A voltage range that is greater than the foregoing range may be used depending on the size of the EMR (e.g., when the EMR is scaled up). A voltage range for the second EMR may be smaller than the voltage range for the first EMR. The one or more ionized elements are reduced (e.g., chemically reduced) to produce one or more reduced elements. The one or more ionized elements are reduced to metallic form, which may be electroplated on the surface of the working electrode. By way of example only, Cu²⁺ ions in the lithium-containing solution 115 may be reduced to Cu, which is electroplated on the surface of the working electrode. The one or more ionized elements may be oxidized to metal oxide form, which may be deposited on the surface of the working electrode. By way of example only, Mn²⁺ ions in the lithium-containing solution 115 may be oxidized to MnO₂, which is deposited on the surface of the working electrode. The one or more reduced elements may be removed (that is, precipitated) from the lithium-containing solution 115 to produce a lithium enriched stream 140. The pH of the lithium-containing solution 115 may be sequentially adjusted to different values to precipitate the one or more elements. The one or more reduced elements may be precipitated by, for example, adjusting the pH of the lithium-containing solution 115. For example, the pH may be increased/decreased from a pH of about 0 to a pH of about 13. The method may further comprise introducing one or more of an NaCl solution, an HCl solution, and a Na₂SO₄ solution to the second chambers 118a, 118b, and the third chambers 122a, 122b of the first electrochemical membrane reactor. Introducing the one or more solutions (e.g., one or more of NaCl, HCl, Na₂SO₄ solution) may adjust solution concentration to prevent the solution from having a high concentration (e.g., maintaining a relatively dilute solution). A voltage may be applied to the first electrochemical membrane reactor, causing one or more of Cu²⁺, Zn²⁺, Co²⁺, Ni²⁺, Pb²⁺, Ag⁺, Pt²⁺, and Au³⁺ ions to electroplate in their metallic form, causing Mn²⁺ ions to oxidize to MnO₂, and the pH of the lithium-containing solution 115 to be adjusted to generate one or more of H₂SO₄, NaCl, HCl, U(OH)₄, Th(OH)₄, Ga(OH)₃, Cr(OH)₃, Al(OH)₃, Fe(OH)₃, Co(OH)₃, Ni(OH)₃, Zr(OH)₄, Cd(OH)₂, Sc(OH)₃, Y(OH)₃, lanthanides(OH)₃ (hydroxide compounds of lanthanide elements), Mn(OH)₂, and Mg(OH)₂. One or more of Cl⁻, U⁴⁺, Th⁴⁺, Cu²⁺, Zn²⁺, Pb²⁺, Co²⁺, Ni²⁺, Ag⁺, Pt²⁺, Au³⁺, Fe³⁺, Pb²⁺, Cr³⁺, Al³⁺, Ga³⁺, Zr⁴⁺, Cd²⁺, Sc³⁺, Y³⁺, lanthanides³⁺, Mn²⁺, and Mg²⁺ ions may be removed from the lithium-containing solution 115 (e.g., in the form of compounds of one or more of these ions) to produce the lithium enriched stream 140. The lithium enriched stream 140 may be introduced into the second electrochemical membrane reactor (second EMR). A voltage may be applied across the electrodes of the second electrochemical membrane reactor to produce a LiOH solution from the lithium enriched stream 140. The lithium in the lithium-containing solution, which may include one or more of the lithium-ion battery materials, such as MnO₂ particles and LiMn₂O₄ particles, may be removed to produce a residual stream that is substantially free of lithium. The generated, concentrated LiOH solution may be separated from the delithiated battery materials and the lithium in the LiOH solution is recovered. The process may further comprise suspending lithium-ion battery materials, such as MnO₂ particles, in the lithium-enriched stream and suspending lithiated materials, such as LiMn₂O₄, in the diluted LiOH solution. Lithiated materials, such as LiMn₂O₄, may come from the cathode chamber from the last extraction. If it is a first use of the second EMR to extract lithium from a lithium-containing solution, LiMn₂O₄ may come from a sysnthese process, such as calcinating LiOH with MnO₂ particles. The suspension of the lithium-ion battery material and the lithiated battery material, such as MnO₂ and LiMn₂O₄ suspensions, may be formed by one or more of applying vortex shaking, mechanical stirring, and ultra-sonication to the second electrochemical membrane reactor. The two suspensions (e.g., the MnO₂ and LiMn₂O₄ suspensions) may be passed through the second electrochemical membrane reactor. The lithium may be recovered from the lithium-containing solution 115 and used as a starting material in a process or product that includes lithium. By way of example only, the recovered lithium may be used as a starting material or a component of lithium ion batteries.

As shown in FIGS. 1A-1C and FIG. 1F, lithium-containing solution 115 (e.g., brine) may be introduced (e.g., poured) into first chamber 114 of first electrochemical membrane reactor 110a. A dilute electrolyte solution 134 (e.g., dilute NaCl solution or dilute HCl solution) is flowed through the second chambers 118a, 118b, and a metal sulfate solution 136 (e.g., Na₂SO₄ solution or K₂SO₄ solution) is flowed through third chambers 122a, 122b. Upon applying a voltage to the first electrochemical membrane reactor 110a, the counter electrodes 126a, 126b (e.g., anodes) oxidize H₂O to produce H⁺ ions and O₂, or the anode material itself may be oxidized to produce ions. Na⁺ ions may travel from the third chamber 122a to the second chamber 118a through the first cation exchange membrane 120a and combine with Cl⁻ ions, which may travel from the first chamber 114 to form NaCl. A concentrated solution 139 (e.g., concentrated NaCl, concentrated HCl) may exit the second chambers 118a, 118b. By-product 137 (e.g., H₂SO₄, Na₂SO₄), may exit third chambers 122a, 122b. The bipolar membranes 128a, 128b may split H₂O to H⁺ and OH⁻ ions. The H⁺ ions may travel to the second chamber 118a through the bipolar membranes 128a, 128b and combine with Cl⁻ ions from the first chamber 114 to form HCl. The OH⁻ ions may travel to third chamber 122a through the bipolar membranes 128a, 128b and neutralize the H⁺ ions generated from the counter electrodes 126a, 126b. The bipolar membranes 128c, 128d may combine the H⁺ and OH⁻ ions to produce H₂O. The H⁺ ions may travel from third chambers 122a, 122b through bipolar membranes 128c, 128d and combine with the OH⁻ ions, which may travel from second chambers 118a, 118b to form H₂O. The electrochemical membrane reactor may include one or more Metal Frame Porous Electrodes (e.g., porous working electrode 112). The pore size of the Metal Frame Porous Electrodes may be from micrometer to millimeters in size. The pores (in embodiments, from about 10 to ≥1,000 micrometers in size) in the MFPE may facilitate ion transmission through itself, which may allow the inner part of the porous electrode to be involved in the electrochemical reaction. Therefore, the three-dimensional MFPE may have a significantly larger electrode/electrolyte interface surface area than a conventional plate electrode, which may increase the reaction rate and reduce the processing time. The working electrode(s) in the first chamber 114 utilized in the first EMR may extract elements through one or more of the following reaction mechanisms: an electroplating mechanism, by which one or more of Cu²⁺, Zn²⁺, Pb²⁺, Fe²⁺, Sn²⁺, Sb³⁺, Cd²⁺, Co²⁺, Ni²⁺, Ag⁺, Pt²⁺, and Au³⁺ ions may be extracted from the lithium-containing solution 115; their electroplating potentials being above or near to the H₂ evolution potential, an electrochemical precipitation mechanism, where H₂O and/or air may be reduced to H₂ and OH⁻ ions, increasing the pH value of the lithium-containing solution and precipitating one or more of U⁴⁺, Th⁴⁺, Zn²⁺, Co²⁺, Ni²⁺, Fe³⁺, Ga³⁺, Cr³⁺, Al³⁺, Zr⁴⁺, Cd²⁺, Sc³⁺, Y³⁺, lanthanides³⁺, Mn²⁺, and Mg²⁺ ions, and an electrochemical deposition mechanism, wherein Mn²⁺ ions may be oxidized to MnO₂, which deposit on the working electrode. A purified solution 140 (e.g., a lithium-enriched stream) exits chamber 114 and is introduced to the second EMR 200a, 200b.

In order to remove the precipitates (e.g., Zn²⁺, Co²⁺, Ni²⁺, Fe³⁺, Ga³⁺, Cr³⁺, Al³⁺, Zr⁴⁺, Cd²⁺, Sc³⁺, Y³⁺, lanthanides³⁺, Mn²⁺, and Mg²⁺ ions) from the MFPE(s) and clean the MFPE(s), in embodiments of the disclosure, the MFPE(s) may be coated with a layer of nanocarbon particles, which is bonded on the surface of the electrode with a polymer binder, e.g., one or more of polyvinylidene fluoride (PVDF), polytetrafluoroethylene (PTFE), NAFION® (sulfonated tetrafluoroethylene-based fluoropolymer copolymer), cation exchange ionomers, and anion exchange ionomers. One or more of ultrasound cleaning and calcination can be utilized to clean the carbon layer and remove any residual precipitation remaining on the MFPE(s).

Brine is a complex composition of elements or analytes. If the lithium-containing solution 115 is brine, the elements or analytes shown in Table 1 may be present. By way of example only, the geothermal brine composition of Table 1 may be from the Salton Sea.

TABLE 1
Salton Sea Geothermal Brine Chemical Composition

| Element or | Mean | Element or | Mean |
|---|---|---|---|
| Analyte | (mg/L) | Analyte | (mg/L) |
| Cl | 142,015 | Br | 91 |
| Na | 49,249 | Pb | 84 |
| Ca | 25,684 | Cs | 20 |
| K | 14,467 | I | 17 |
| Fe | 1347 | F | 15 |
| Mn | 1201 | As | 9.0 |
| Zn | 463 | Cu | 4.1 |
| Sr | 434 | Al | 2.4 |
| B | 298 | Cd | 1.9 |
| Ba | 205 | Ag | 1.6 |
| Li | 202 | SiO₂ | 342 |
| Rb | 110 | NH₄ | 311 |
| Mg | 109 | SO₄ | 58.6 |

Table 2 shows examples of extraction reactions, their thermal dynamic electroplating potentials, and the pH ranges where targeted materials precipitate from a lithium-containing solution, such as brine. The brine may be a geothermal brine from the Salton Sea, which includes the elements shown in Table 1.

TABLE 2
Reaction mechanisms of elements extracted from a lithium-containing solution using the first EMR

| | | Thermodynamic potential for electroplating or pH |
|---|---|---|
| | Reaction mechanism | precipitation |
| Electroplating | Pt²⁺ + 2e⁻ → Pt (1) | Pt²⁺/Pt: E₀ = 1.88 + 0.02951 logₚₜ₊ |
| | Au³⁺ + 3e⁻ → Au (2) | Au³⁺/Au: E₀ = 1.498 + 0.0197log_{Au3+} |
| | Ag⁺ + e⁻ → Ag (3) | Ag⁺/Ag: E₀ = 0.799 + 0.0591log_{Ag+} |
| | Cu²⁺ + 2e⁻ → Cu (4) | Cu²⁺/Cu: E₀ = 0.337 + 0.0295logC_{Cu2+} |
| | Pb²⁺ + 2e⁻ → Pb (5) | Pb²⁺/Pb: E₀ = −0.126 + 0.0295logC_{Pb2+} |
| | Cd²⁺ + e⁻ → Cd (6) | Cd²⁺/Cd: E₀ = −0.403 + 0.0295logC_{Cd2+} |
| | Fe²⁺ + e⁻ → Fe (7) | Fe²⁺/Fe: E₀ = −0.44 + 0.0295logC_{Fe2+} |
| | Zn²⁺ + e⁻ → Zn (8) | Zn²⁺/Zn: E₀ = −0.763 + 0.0295logC_{Zn2+} |
| | Ni²⁺ + 2e⁻ → Ni (9) | Ni²⁺/Ni: E₀ = −0.25 + 0.0295logC_{Ni2+} |
| | Co²⁺ + 2e⁻ → Co (10) | Co²⁺/Co: E₀ = −0.277 + 0.0295log C^{Co2+} |
| Electrochemical | 2H₂O + 4e⁻ →H₂ + 2OH⁻(11) | H⁺/H₂: E₀ = −0.0591 pH |
| precipitation | 2H₂O + O₂ + 4e⁻ →4OH⁻(12) | O₂/H₂O: E₀ = 1.228 −0.0591 pH |
| | U⁴⁺ + 4OH⁻→U(OH)₄↓(13) | K_{sp, U(OH)4} = 6.31 × 10⁻⁵³, precipitate: pH >~1.2 |
| | Th⁴⁺ + 4OH⁻→Th(OH)₄↓(14) | K_{sp, Th(OH)4} = 2.951 × 10⁻⁴⁹, precipitate: pH >~2.12 |
| | Ga³⁺ + 4OH⁻→Ga(OH)₃↓(15) | K_{sp, Ga(OH)3} = 7.28 × 10⁻³⁶, precipitate: pH >~2.6 |
| | Al³⁺ + 3OH⁻→Al(OH)₃↓(16) | K_{sp, Al(OH)3} = 1.9 × 10⁻³³, precipitate: pH >~3.5 |
| | Zn²⁺ + 2OH⁻→Zn(OH)₂↓(17) | K_{sp, Zn(OH)2} = 4.5 × 10⁻¹⁷, precipitate: pH >~6.32 |
| | Fe²⁺ + 2OH⁻→Fe(OH)₂↓(18) | K_{sp, Fe(OH)2} = 7.9 × 10⁻¹⁵, precipitate: pH >~7.5 |
| | Fe³⁺ + 2OH⁻→Fe(OH)₃↓(19) | K_{sp, Fe(OH)3} = 2.5 × 10⁻³⁹, precipitate: pH >~147 |
| | Mn²⁺ + 2OH⁻→Mn(OH)₂↓(20) | K_{sp, Mn(OH)2} = 1.6 × 10⁻¹³, precipitate: pH >~8.1 |
| | Mg²⁺ + 2OH⁻→Mg(OH)₂↓(21) | K_{sp, Mg(OH)2} = 1.5 × 10⁻¹¹, precipitate: pH >~−1.37 |
| | Zr⁴⁺ + 4OH⁻→Zr(OH)₄↓(22) | K_{sp, Zr(OH)4} = 3.2 × 10⁻⁶³, precipitate: pH >~9 |
| | Cr³⁺ + 2OH⁻→Cr(OH)₄↓(23) | K_{sp, Cr(OH)3} = 6.7 × 10⁻³¹, precipitate: pH >~4.28 |
| | Ni²⁺ + 2OH⁻→Ni(OH)₄↓(24) | K_{sp, Ni(OH)2} = 2.8 × 10⁻¹⁶, precipitate: pH >~6.72 |
| | Co²⁺ + 2OH⁻→Co(OH)₂↓(25) | K_{sp, Co(OH)2} = 5.92 × 10⁻¹⁶, precipitate: pH >~6.89 |
| | Sc³⁺ + 2OH⁻→Sc(OH)₃↓(26) | K_{sp, Sc(OH)3} = 2.22 × 10⁻³¹, precipitate: pH >~4.11 |
| | Y³⁺ + 2OH⁻→Y(OH)₃↓(27) | K_{sp, Y(OH)3} = 1.0 × 10⁻²², precipitate: pH > ~7 |
| | Lanthanides³⁺ + 3OH⁻ | K_{sp, Lanthanides(OH)3} = 1.0 × 10⁻²⁰ to ~1.00 × 10⁻²⁴, |
| | →Y(OH)₃↓(28) | precipitate: pH >~7 = 6.4 |

Cl⁻ ions from the brine may coordinate with metal ions, affecting their precipitation. For example, Cl⁻ ions may coordinate with Al³⁺ and Fe³⁺ ions to form [AlCl₄]⁻ and [FeCl₄]⁻ complex ions. The pH of the brine may be raised higher than the pH values stated in Table 2 in order to precipitate some of the metal ions. Air may be introduced (e.g., sparged) into the brine to aerate the solution and thus oxidize Fe²⁺ to Fe³⁺ ions. At a pH of about 7, about 99% of Fe²⁺ ions may be oxidized in less than about 50 minutes, and Mn²⁺ ion oxidation may be negligible. Dissolved O₂ (naturally occurring from air sparging) may also be electrochemically reduced to produce OH ions, which may increase the pH of the brine solution. After the oxidation of Fe²⁺ to Fe³⁺ ions, air sparging may not be used and the pH of the brine solution may be increased by electrochemically reducing H₂O and O₂ to produce OH⁻. When the pH of the brine is adjusted, in embodiments to about 8.5, by the first electrochemical membrane reactor, the concentrations of those elements, including one or more of Cu²⁺, Ga³⁺, Zn²⁺, Co²⁺, Ni²⁺, Ag⁺, Pt²⁺, Au³⁺, Fe³⁺, Fe²⁺, Pb²⁺, Cr³⁺, Al³⁺, Zr⁴⁺, Cd²⁺, Sc³⁺, Y³⁺, lanthanides³⁺, Mn²⁺, and Mg²⁺ ions, may be reduced to less than about 1 ppm through one or more of the electroplating reactions or electrochemical precipitation reactions. When the pH is further elevated in the electrochemical membrane reactor to greater than about pH 8.5, Mn²⁺ ions may start to precipitate as hydroxides. When the pH reaches about 10, greater than about 99% of Mn²⁺ ions may be extracted as hydroxides and less than about 10 ppm of Mn²⁺ ions may remain soluble in the brine. With the pH continuously increasing above about pH 10, Mg²⁺ ions may further precipitate and less than about 1 ppm of Mg²⁺ ions may remain in the brine by about pH 11.5. The electrochemical membrane reactor may not only extract metal ions, but may also generate valuable byproducts including one or more of Ga(OH)₃, REEs(OH)₃, Mn(OH)₂, Mg(OH)₂, NaCl, HCl, Na₂SO₄, and H₂SO₄, which may be recovered.

The purified solution 140 (e.g., lithium enriched stream) produced by (e.g., prepared with) the first electrochemical membrane reactor may be introduced (e.g., poured) into the cathode chamber 212 of the second electrochemical membrane reactor 210a, as shown in FIG. 2A. The purified solution 140 may include nanoparticles of lithium ion battery materials and lithiated battery materials, such as MnO₂ and LiMn₂O₄ nanoparticles. The particles of lithium ion battery materials, such as MnO₂ particles, may be suspended in the purified solution 140. The purified solution 140 may flow through the MFPE 212. A nanoparticle solution 250 (e.g., nanoparticle-sized lithiated battery materials, such as LiMn₂O₄ particles, from a previous extraction cycle) may be suspended inside a low concentrate LiOH solution and may be introduced (e.g., poured) into second chambers 218a, 218b. For the first use cycle of Li extraction, lithiated battery materials, such as LiMn₂O₄ particles, may be generated by calcining Li₂CO₃ or LiOH with MnO₂. With appropriate voltage applied to the second electrochemical membrane reactor 210a, Li⁺ ions may intercalate into the lithium-ion battery materials, such as MnO₂ particles, in the porous cathode 212, and Li⁺ ions may de-intercalate out from lithiated battery materials, such as LiMn₂O₄ particles, on the anode 226a, 226b side. A nanoparticle stream 252 (e.g., LiMn₂O₄ nanoparticles in brine) exits middle chamber 214. A nanoparticle stream 254 (e.g., λ-MnO₂ nanoparticles in concentrated LiOH) exits chambers 218a, 218b of the second electrochemical membrane reactor 210a.

In embodiments of the disclosure, the lithium enriched stream 140 from the first EMR may be introduced into the second electrochemical membrane reactor. One or more of MnO₂, graphite, FePO₄, Li_{2-x′}TiO₃, and Li_{1-x′}NiₓMn_{y}Co_{z}O₂ (x+y+z=1) particles may be suspended in the lithium enriched stream. Mechanic stirring, Vortex shaking, or ultrasound may maintain the stability of the suspension. One or more of the lithiated particles, such as LiMn₂O₄, Li-graphite, LiFePO₄, Li₂TiO₃, and LiNiₓMn_{y}Co_{z}O₂ (x+y+z=1), which may be obtained, for example, from the last lithium extraction or from calcination of MnO₂, graphite, FePO₄, Li_{2-x′}TiO₃, and Li_{1-x′}NiₓMn_{y}Co_{z}O₂ (x+y+z=1) particles with LiOH, may form in the suspension. When suspending the MnO₂, graphite, FePO₄, Li_{2-x′}TiO₃, and Li_{1-x′}NiₓMn_{y}Co_{z}O₂ (x+y+z=1) particles in the lithium enriched stream, and suspending LiMn₂O₄, Li-graphite, LiFePO₄, Li₂TiO₃, and LiNiₓMn_{y}Co_{z}O₂ (x+y+z=1) in dilute LiOH solution, pouring those suspensions into the cathode and anode chambers of the second EMR, applying voltage to the second EMR, the lithium from the lithium-enriched stream is extracted and the lithium in the lithiated battery particles is released into the dilute LiOH solution. Optionally, the suspensions inside the EMR may be stabilized, such as through one or more of Vortex shaking, stirring, and ultrasound treatment. or more of Al₂O₃ and ZrO₂ can coat on to the particles of battery material, MnO₂, graphite, FePO₄, Li_{2-x′}TiO₃, Li_{1-x′}NiₓMn_{y}Co_{z}O₂ (e.g., can form a layer on the particles of battery material) to increase their durability and stability.

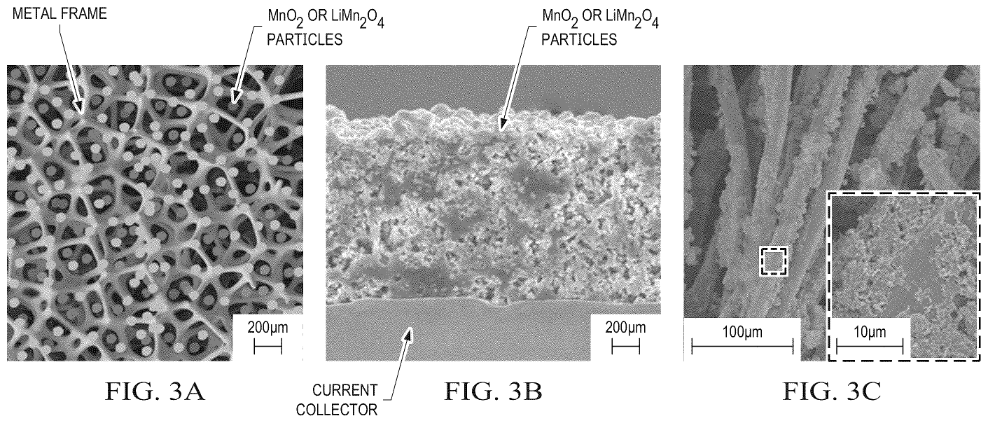

In the meantime, water may be split into H⁺ and OH⁻ ions by the BPMs, while H⁺ ions may travel to the cathode side and OH⁻ ions may travel to the anode side. Alternately, water may be produced by the BPMs, while H⁺ ions may travel from the anode side and OH⁻ ions may travel from the cathode side. The nanoparticles in the nanoparticle stream 252 may be homogenously suspended in the lithium enriched stream 140 (e.g., enriched brine) produced in the first electrochemical membrane reactor 110a, and this may reduce the diffusion distance of Li⁺ ions inside the metal frame porous electrode, as shown in FIG. 3A. By comparison, a conventional paste electrode and conventional 3D flow-through electrode have MnO₂ particles confined on the surface of the current collector, as shown in FIG. 3B and FIG. 3C, respectively, increasing ion diffusion distance.

FIG. 2B shows the system 200b including the second electrochemical membrane reactor 210b. Porous working electrode 212 (e.g., porous cathode) is disposed in chamber 214. Porous counter electrode 227 (e.g., porous anode) is disposed in chamber 219 (e.g., anode chamber). Bipolar membrane 228 is between cathode chamber 214 and anode chamber 219. Mechanical stirrers 238a, 238b are disposed in chambers 214 and 219. One or more of MnO₂, graphite, FePO₄, Li₂₋ₓ TiO₃, and Li_{1-x′}NiₓMn_{y}Co_{z}O₂ (x+y+z=1) particles may be suspended in the purified solution 140 (e.g., lithium enriched stream) forming a suspension 141. Mechanical stirring, Vortex shaking, or ultrasound may maintain the stability of the suspension 141. The suspension 141 may be introduced into the porous cathode chamber 214 of the second electrochemical membrane reactor 210b. One or more of the lithiated particles, such as such as LiMn₂O₄, Li-graphite, LiFePO₄, Li₂TiO₃, and LiNiₓMn_{y}Co_{z}O₂ (x+y+z=1), which may be, for example, from a previous lithium extraction or from the calcination of MnO₂, graphite, FePO₄, Li_{2-x′}TiO₃, and Li_{1-x′}NiₓMn_{y}Co_{z}O₂ (x+y+z=1) particles with LiOH (or Li₂CO₃), may be suspended in the dilute LiOH solution forming suspension 143. The suspension 143 may be introduced into the porous anode chamber 219 of the second electrochemical membrane reactor 210b. With appropriate voltage applied to the second electrochemical membrane reactor 210b, similar reactions to those described above may occur, with product stream 260 exiting cathode chamber 214 and product stream 262 exiting anode chamber 219. Product stream 260 may comprise, nanoparticle size, lithiated lithium-ion battery materials suspended in solution, for example, LiMn₂O₄ particles (e.g., nanoparticle sized lithium-ion battery materials) suspended in solution. Product stream 262 may comprise, for example, one or more de-lithiated compounds, for example, MnOₓ particles (e.g., de-lithiated lithium ion battery materials) suspended in dilute LiOH solution.

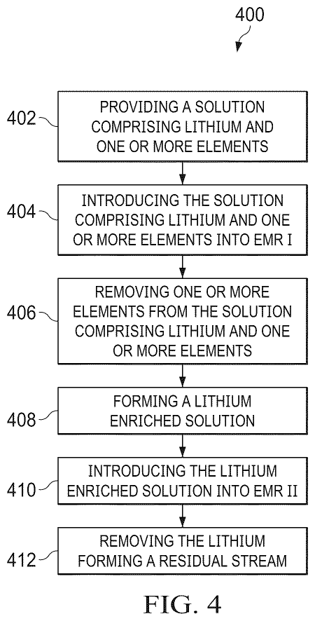

FIG. 4 is a flow diagram showing a method 400 of separating elements and removing (e.g., extracting) lithium from the lithium-containing solution (e.g., brine) in accordance with embodiments of the disclosure. The method 400 may comprise providing 402 a solution comprising lithium and one or more elements (e.g., natural brine) and introducing 404 the solution comprising lithium and one or more elements into a first electrochemical membrane reactor (EMR I). The method 400 includes removing 406 (e.g., extracting) one or more elements (e.g., one or more of silver, cadmium, aluminum, iron, manganese, copper, magnesium, lead, zinc, nickel, cobalt, chromium, gold, platinum, and rare earth elements) from the solution comprising lithium and one or more elements and forming 408 a lithium enriched solution (e.g., an enriched brine, lithium enriched stream). Method 400 further includes introducing 410 the lithium enriched solution into a second electrochemical membrane reactor (EMR II) and removing (e.g., extracting) 412 the lithium and forming a residual stream.

Elements comprising one or more of U, Th, Ga, Cr, Zr, Ag, Cu, Cd, Fe, Al, Zn, Pb, Mn, Mg, REEs, Li, and some amount of the Cl may be removed (e.g., extracted) in the methods utilizing the first and second electrochemical membrane reactors and may generate valuable byproducts. By way of example only, natural brine may be processed in the first electrochemical membrane reactor using extraction to remove one or more elements, such as one or more of U, Th, Ga, Cr, Zr, Ag, Cu, Cd, Fe, Al, Zn, Pb, Mn, Mg, and REEs, to produce the lithium enriched solution (e.g., lithium enriched brine). The lithium enriched stream generated by the first electrochemical membrane reactor may be processed in the second electrochemical membrane reactor and lithium may be recovered (e.g., extracted) from the lithium enriched solution in the second electrochemical membrane reactor. The lithium enriched solution is processed in the second electrochemical membrane reactor, the lithium may be extracted therefrom, and the residual stream (which may be substantially free of lithium) may be safely discharged into the environment. The lithium recovered from the method 400 may then be used as a starting material in a new process or product.

After processing in the first EMR, the lithium enriched stream may contain less than or equal to about 1 ppm of the above elements (such as less than about 1 ppm of one or more of uranium, thorium, gallium, silver, cadmium, aluminum, iron, manganese, copper, magnesium, lead, zinc, rare earth elements, nickel, cobalt, chromium, zirconium, chromium, gold, and platinum) and may be in an improved form for extraction of Li with high purity as compared to unprocessed liquid. As described herein, the first EMR may be utilized to process the lithium enriched stream prepared with the first EMR.

MnO₂ nanoparticles may be synthesized having different sizes and their electrochemical properties may be determined to determine the stability time of those particles suspended inside natural brine. The configuration of first electrochemical membrane reactor may be selected considering the ionic conductivity of the lithium-containing solution (e.g., brine) in the metal frame foams with different pore densities. The electrochemical properties of the MnO₂ nano-particles suspension in the reactor both static way and flowing way may be considered. The second electrochemical membrane reactor having a semi-solid flowing structure may extract Li with one or more of about 99% purity, greater than about 95% extraction efficiency/cycle, greater than about 75.06 mg·g⁻¹·h⁻¹ extraction rate, and greater than about 500 cyclability at the Li extraction capacity retention of about 80%.

MnO₂ nanoparticles may be synthesized by chemical reaction between aqueous KMnO₄ solution and 2,3-butanediol, and the particle size may be controlled by adjusting the 2,3-butanediol/KMnO₄ ratio. MnO₂ may be fabricated to prepare an ink electrode to test its electrochemical properties in LiCl, NaCl and KCl solution measuring the Li extraction capacity. The synthesized battery material particles, such as MnO₂ particles, may be coated with a Al₂O₃ layer, or a ZrO₂ layer, to increase battery material stability, especially at low voltage conditions.

Different size MnO₂ nanoparticles may be suspended inside a solution (e.g., brine) such as by Vortex shaking, mechanical stirring, and/or ultra-sonication. The sedimentation dynamics may be characterized by measuring the suspension's transmission value with a photo-centrifuge device, and the relationship between stability time of the suspension and particle size determined.

The following examples serve to explain embodiments of the disclosure in more detail. These examples are not to be construed as being exhaustive or exclusive as to the scope of the disclosure.

### EXAMPLES

### Example 1

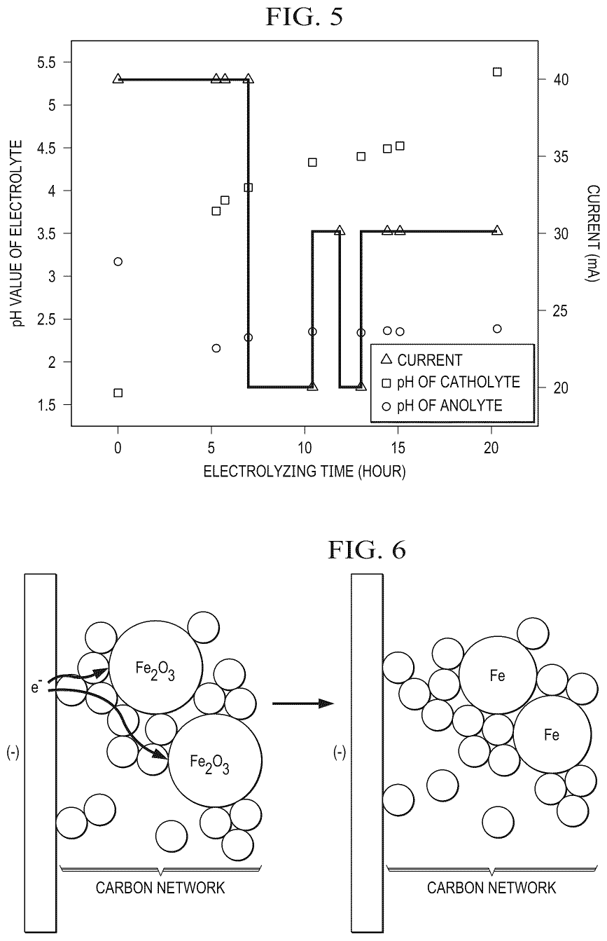

A benchtop scale first EMR electrochemical membrane reactor was employed to extract elements, including but not limited to, one or more of uranium, thorium, gallium, silver, silver, cadmium, aluminum, iron, manganese, copper, magnesium, lead, zinc, rare earth elements, nickel cobalt, chromium, zirconium, gold, and platinum, from a lithium-containing solution (e.g., an aqueous solution), to produce a lithium enriched stream. FIG. 5 is a graph showing the pH increase of the electrolytes with the applied current over electrolysis time for the first EMR reactor.

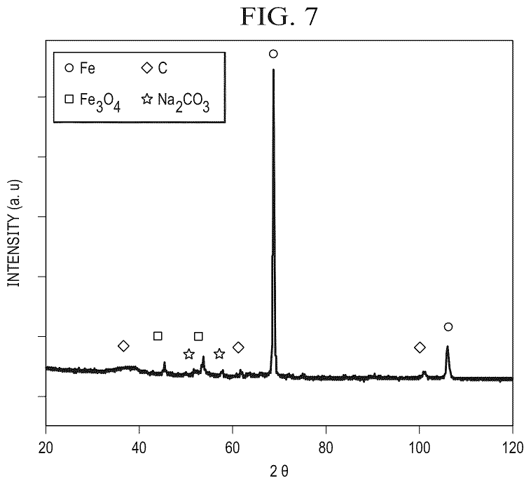

FIG. 6 illustrates a carbon network, which may approximate a MFPE, and which may be selected in embodiments of the disclosure. When the second EMR is utilized, the MFPE may function as a network with sufficient electrical conductivity to transfer electrons to flowing battery materials, such as MnO₂ particles, and transfer electrons from lithiated battery materials, such as LiMn₂O₄ particles. As shown in FIG. 6, an Fe₂O₃ colloidal electrode was fabricated to produce iron. The electrode was flowable. The electrode was prepared by mixing Fe₂O₃ powder, carbon powder, NaOH and water. The function of the carbon powder was to establish a network with electrical conductivity for the purpose of transferring electrons to Fe₂O₃ particles, as shown in FIG. 6. XRD analysis of the product demonstrated that greater than about 90% of Fe₂O₃ particles were reduced to Fe particles by the carbon network as shown in FIG. 7. Another carbon network successfully achieving electrochemical reaction was the semi-solid lithium rechargeable flow battery, which employs a flowable colloid cathode made from LiNi_{0.5}Mn_{1.5}O₄, carbon black and electrolyte, and a flowable colloid anode made from graphite, carbon black and electrolyte. That battery can cycle in the specific capacity of about 150 mAh/g (milliampere-hours per gram mass) several times. The carbon network inside the colloids functioned as an electric conductor. However, the carbon network was established by carbon particles contacting each other, and the contact resistance may be large when the network is long. Therefore, these colloidal electrodes may not be very thick, with the thickness of the colloid for iron production selected to be less than 2 mm. To overcome the drawback that conventional colloidal electrodes have, the second EMR has the porous metal frame as its network to transfer electrons. The electrical conductor is a contiguous piece and does not have the contact resistance that the carbon network in a colloidal electrode has. The second EMR electrode may be fabricated to be much thicker and accommodate a greater quantity of MnO₂ or LiMn₂O₄ nano particles as compared to the colloidal electrodes, which may increase Li extraction yield. Both nanoparticles and porous electrodes have a high surface area. Pore size and length of the MFPE are selected so that the flowing nanoparticles may collide with the metal frame and be involved in the electrochemical reaction completely. Carbon black nanoparticle may be coated on the metal frame porous electrode to further increase the electric conductivity.

Variations of a benchtop scale first electrochemical membrane reactor were employed to extract Cu, Al and Fe from a complex aqueous solution containing Mn, Co, Ni, Cu, Al and Fe. In one embodiment, a plate working electrode was utilized in the first electrochemical membrane reactor. In another embodiment, a porous electrode was utilized in place of the plate electrode. The porous electrode accelerated the extraction process and reduced the extraction time as compared with the plate electrode. The main body of the first electrochemical membrane reactor comprised a three-cylinder “H” cell with two pieces of anion exchange membrane (FUMASEP® FAA-3-PK-130) sandwiched between two of the three adjacent cylinders. A Ni foam (5 cm×30 cm, pore density 110 ppi, MTI Corporation) was coiled and inserted into the middle cylinder, functioning as a cathode, and two Ni plates or platinum foils were applied as the counter electrodes in both sides of the cylinders. 0.2 mol/l⁻¹ Na₂SO₄ solution was used as the anolyte inside the two side cylinders. The two-anode design significantly increased the uniformity of the potential distribution on the cathode, improving Cu, Fe and Al extraction selectivity, and reducing the processing time. Two different aqueous solutions were tested. The composition of Solution 1 was: 9,782 ppm Co, 11,740 ppm Ni, 43,920.0 ppm Mn, 3,240.8 ppm Cu, 2,536.1 ppm Al, and 1,117 ppm Fe, and the anions were SO₄²⁻ ions. Solution 2 had the same composition as Solution 1 except for 46,952 ppm Ni, 10,988 ppm Mn, and 3,240.8 ppm Cu. Solution 1 was electrolyzed in the first electrochemical membrane reactor by using Ni plates as the anode. Cu from the solution electroplated on the coiled Ni foam from the outside to the inside layer. FIG. 5 shows the pH of the solution inside the cathode cylinder was increased from a pH of about 1.6 to about 5.4 after electrolysis for 20 hours. When the pH of the solution had increased to pH 4.2, O₂ was purged into the middle cylinder until the pH increased to about 5.4. Cu, Al and Fe were extracted from the solution according to equations (4), (16) and (19) in Table 2 shown above. The solutions before and after electrolysis were analyzed by iCAP Q ICP-MS and Agilent 240FS AA instruments. Table 3 shows four sets of experimental results, which demonstrate the first electrochemical membrane reactor successfully extracted Cu, Al and Fe from the two solutions with remaining solution containing Cu, Al and Fe sum concentrations of less than or equal to about 5 ppm, and greater than about 95% of Ni, Co, and Mn remain inside the solution.

TABLE 3
Impurity concentration and Ni, Co, and Mn recovery efficiency
(RE) After the First EMR Processed the Simulated Leachate

| Simulated leachate | Cu/ppm | Al/ppm | Fe/ppm | Ni RE | Co RE | Mn RE |
|---|---|---|---|---|---|---|
| Solution 1 (Ni anode) | <0.5 | 0 | 0 | 99.5% | 95.4% | 99.14% |
| Solution 1 (Ni anode) | 0 | 0 | 5.0 | 95.5% | 97.7% | 99.3% |
| Solution 1 (Pt anode) | 1.0 | 2.3 | 0 | 96.3% | 98.8% | 99.9% |
| Solution 2 (Ni anode) | 0.01 | 3.7 | 0 | 94.3% | 98.2% | 99.4% |

After the electrochemical extraction, the processed solution inside the middle cylinder was discharged, and replaced with 0.2 mol/l⁻¹ Na₂SO₄ solution. The polarity of the reactor was switched and the dissolved Ni²⁺ ions from the anode plate electroplated back to the Ni plate. Ni²⁺ ion concentrations in the two side cylinders were about 3105 ppm at the end of the extraction process and the concentration decreased to about 26.6 ppm after the dissolved Ni electroplated back to the anode. The capacity efficiency of Ni recovery was about 83.9%. After recovering Ni, the pH of the electrolyte in the middle cylinder decreased to 0.96, due to the H₂SO₄ byproduct. The reactor extracted Cu, Al, and Fe and kept Ni, Co, and Mn in solution. However, the first electrochemical membrane reactor may extract all the elements which can be electroplated and precipitated from brine, so there is much less complexity in the process. Based on the extraction of Cu, Al and Fe from Solution 1 and Solution 2, the first electrochemical membrane reactor was capable of extracting fifteen or more elements, including one or more of U, Th, Ga, Cr, Zr, Ag, Cu, Cd, Fe, Al, Zn, Pb, Mn, Mg and REEs, from brine, lowering their concentration to about 1 ppm, when the pH was increased to about 11.5.

The brine from Salton Sea may have greater than about 20 weight % of dissolved solids and may exhibit intrinsic ionic conductivity, especially when the temperature is high. The MFPE (MFPC and MFPA) may have pores of from micrometer to millimeter in size, such as from about 10 micrometers to ≥1,000 micrometers. The larger sized pores in the MFPE may allow ions and particles to easily travel through the electrode body. These two factors may impart excellent ionic conductivity to the MFPE. The metal frame of the MFPE (in embodiments, made from one or more of carbon, a metal, such as one or more of Ni, Ti, and Cu metal) may exhibit an excellent electrical conductivity.

The first electrochemical membrane reactor may have particles directly in contact with the metal frame porous electrode and may have a large surface area which may reduce ohmic resistance. The standard intercalation potentials for Li⁺, Na⁺, and K⁺ ions are 0.912-1.03 V (vs. SHE) (SHE=standard hydrogen electrode potential), 0.092 V (vs. SHE), and 0.045 V (vs. SHE), and 0.82 V difference is between the extraction reactions of Li⁺ and Na⁺ ions. Considering the influence of Li⁺, Na⁺, and K⁺ ions concentrations on the value of their intercalation potential, there is still around 0.67 V difference between the extraction reactions of Li⁺ and Na⁺ ions. Therefore, if potential distribution on the MFPE is less than 0.67 V, the reactor may only extract Li⁺ ions without extracting any Na⁺ and K⁺ ions. Because of its electric and ionic conductivity, the porous electrode may be fabricated very thick, such as to a thickness of about 1 millimeter to about 1,000 millimeters, and the potential distribution on the porous metal electrode may be under 0.67 V.

The second electrochemical membrane reactor may flow MnOₓ and LiMn₂O₄ nanoparticles through its MFPE, and the reactor configuration and process may overcome or alleviate one or more of the drawbacks associated with conventional electrodialysis reactors. The second electrochemical membrane reactor may be configured to accommodate a larger amount of battery materials and lithiated battery materials, such as MnO₂ and LiMn₂O₄ particles, as compared to conventional reactors. The second electrochemical membrane reactor may be controlled to selectively extract Li⁺ ions without extracting K⁺ and Na⁺ ions by applying an appropriate voltage. For example, a potential of from about 0.9 V (vs. standard hydrogen electrode) to about 1.0 V (vs. standard hydrogen electrode) may be applied to the second electrochemical membrane reactor. The extraction process may be conducted by using the reaction of MnO₂↔LiMn₂O₄ instead of the reaction of MnO₂↔LiMn₂O₄→Mn²⁺. Because the lithium enriched stream which is produced by the first electrochemical membrane reactor may have a final pH value of about 12.5, such a high pH value may prevent LiMn₂O₄ from dissolving into the liquid. The second electrochemical membrane reactor may not use a thermally and mechanically unstable binder; and the BPM may block the diffusion of Cl⁻ ions from the cathode chamber to the anode chamber which may avoid corrosion of the anodes. In embodiments of the disclosure, the MFPE in the first and second electrochemical membrane reactor is free of binder and may be washed. Particles (e.g., MnO₂) may be calcined and washed for recovery. The precipitates from the brine may be removed from the electrode by washing. In contrast, conventional electrodes, such as a paste electrode, cannot be washed and cleaned to remove precipitates because they are structurally fragile. Cl⁻ ions may not corrode the cathode because the cathode has a low potential. Dilute LiOH solution has a high pH and LiMn₂O₄ particles in the anode suspension are also insoluble as well. For at least the above reasons, the first electrochemical membrane reactor may be very robust and capable of being scaled up. The first electrochemical membrane reactor may exhibit one or more of a significantly higher Li⁺ selectivity, a greater extraction efficiency, and a higher yield, as compared with previous reactors. The cyclability of the second electrochemical membrane reactor may be 500 cycles at a lithium extraction capacity retention of about 80%. In embodiments of the disclosure, the second electrochemical membrane reactor may extract at least about 95% of lithium from the lithium enriched stream generated by the first electrochemical membrane reactor per cycle with the generated LiOH having a purity of greater than about 99%, with the Li extraction rate being greater than about >75.06 mg·g⁻¹·h⁻¹. Conventional electrodialysis employing paste electrodes, 3D flow-through electrodes, or packed-bed electrodes may operate for less than 50 cycles having a lithium to magnesium selectivity of about 50 and may not achieve both a high lithium extraction rate and a high lithium extraction efficiency simultaneously. The performances of these three electrodes are compared in Table 4. The paste electrode may have more MnO₂ loading than the flow-through electrode, and it may extract more Li per cycle, but the Li extraction rate is much lower than the 3D flow-through electrode. Those electrodes may not have high enough selectivity to extract Li from brine, and the extracted Li may have less than about 25 wt. % purity. Their cyclability may be about 50 cycles in natural geothermal brines, for the reasons of electrode material degradation mechanisms and precipitate coating on the electrode.

TABLE 4

| | LiMn₂O₄ | | | | |
|---|---|---|---|---|---|
| | loading / | Extraction | Extraction rate / | Li selectivity | |
| Type of electrodes | mg · cm⁻² | efficiency / cycle | mg · g⁻¹ · h⁻¹ | to Mg | Cyclability |
| Paste electrode | 75.06 | ~29% | 2.4 | 57 | <50 |
| 3D flow-through | 40 | ~6.7% | 75.06 | 46 | <50 |
| electrode | | | | | |
| Packed-bed porous | unknown | ~1.6% | unknown | unknown | <50 |
| electrode | | | | | |
| Metal Frame Porous | 6.73 g · L⁻¹ | >95% | >75.06 | >28000 (to | >500 |
| Electrode In Accordance | | | | Mg, Na and | |
| With Embodiments Of | | | | K) | |
| The Disclosure | | | | | |

The embodiments of the disclosure described above and illustrated in the accompanying drawings do not limit the scope of the disclosure, which is encompassed by the scope of the appended claims and their legal equivalents. Any equivalent embodiments are within the scope of this disclosure. Indeed, various modifications of the disclosure, in addition to those shown and described herein, such as alternate useful combinations of the elements described, will become apparent to those of ordinary skill in the art from the description. Such modifications and embodiments also fall within the scope of the appended claims and equivalents.

What is claimed is:

1. A system comprising:
a first electrochemical membrane reactor configured to process a solution comprising lithium and one or more elements, the first electrochemical membrane reactor configured to remove at least one of the one or more elements and to form a lithium enriched stream, the first electrochemical membrane reactor comprising:
one or more working electrodes in a first chamber;
one or more anion exchange membranes in the first chamber;
one or more cation exchange membranes in the second chamber;
a second chamber between one of the one or more anion exchange membranes and one of the one or more cation exchange membranes;
a third chamber between one of the one or more cation exchange membranes and a reactor wall;
one or more counter electrodes in the third chamber;
an inlet for introducing one or more of nitrogen, argon, air, and oxygen into the solution comprising lithium and one or more elements; and
a power source configured to apply a voltage to the first electrochemical membrane reactor; and
a second electrochemical membrane reactor configured to remove lithium from the lithium enriched stream, the first electrochemical membrane reactor coupled to the second electrochemical membrane reactor, the second electrochemical membrane reactor comprising:
one or more working electrodes;
one or more counter electrodes;
one or more bipolar membranes; and
a power source configured to apply a voltage to the second electrochemical membrane reactor.

2. The system of claim 1, wherein the first electrochemical membrane reactor configured to process the solution comprising lithium and one or more elements comprises the first electrochemical membrane reactor configured to process one or more of brine, seawater, oil produced water, gas produced water, a leachate of spent lithium ion batteries, a leachate of mines, a leachate of mine tailings, and wastewater.

3. The system of claim 1, wherein the one or more working electrodes in the first electrochemical membrane reactor comprise one or more of a plate working electrode and a porous working electrode.

4. The system of claim 1, wherein the one or more working electrodes in the first electrochemical membrane reactor comprise one or more plate working electrodes comprising a material formulated to suppress a hydrogen gas evolution reaction.

5. The system of claim 1, wherein the one or more working electrodes in the first electrochemical membrane reactor comprise one or more plate working electrodes comprising one or more of lead, bismuth, and titanium.

6. The system of claim 1, wherein the one or more working electrodes in the first electrochemical membrane reactor comprise one or more porous working electrodes comprising one or more of stainless steel, titanium, nickel alloy, carbon, and copper.

7. The system of claim 1, wherein the one or more working electrodes in the first electrochemical membrane reactor comprise one or more porous working electrodes exhibiting a coating on a surface of the porous working electrode, the coating comprising carbon nanoparticles bonded to the surface of the porous working electrode by one or more of polyvinylidene fluoride, polytetrafluoroethylene, sulfonated tetrafluoroethylene-based fluoropolymer copolymer, cation exchange ionomers, and anion exchange ionomers.

8. The system of claim 1, wherein the one or more counter electrodes in the first electrochemical membrane reactor comprise one or more plate counter electrodes comprising one or more of titanium, titanium coated with iridium oxide, titanium coated ruthenium oxide, platinum, gold, carbon and silver, lead, nickel, iron and copper.

9. The system of claim 1, wherein the first electrochemical membrane reactor further comprises:
one or more of one or more additional plate electrodes and additional porous working electrodes in one or more additional chambers;
one or more additional anion exchange membranes;
one or more additional cation exchange membranes;
one or more additional counter electrodes; and
one or more additional chambers between the one or more additional anion exchange membranes, the one or more additional cation exchange membranes, and one or more reactor walls.

10. The system of claim 1, wherein the second electrochemical membrane reactor further comprises:
one or more of one or more additional working electrodes;
one or more additional counter electrodes; and
one or more additional bipolar membranes.

11. The system of claim 1, wherein the one or more working electrodes in the second electrochemical membrane reactor comprise one or more of a plate working electrode and a porous working electrode.

12. The system of claim 1, wherein the one or more counter electrodes in the second electrochemical membrane reactor comprise one or more of a plate counter electrode and a porous counter electrode.

13. A system comprising:
a first electrochemical membrane reactor configured to process a solution comprising lithium and one or more elements, the first electrochemical membrane reactor configured to remove at least one of the one or more elements and to form a lithium enriched stream, the first electrochemical membrane reactor comprising:
one or more working electrodes in a first chamber;
one or more anion exchange membranes in the first chamber;
one or more bipolar membranes in a second chamber, the second chamber between one of the one or more anion exchange membranes and one of the one or more bipolar membranes;
a third chamber between one of the one or more bipolar membranes and a reactor wall;
one or more counter electrodes in the third chamber; and
an inlet for introducing one or more of nitrogen, argon, air, and oxygen into the solution comprising lithium and one or more elements; and a power source configured to apply a voltage to the first electrochemical membrane reactor; and
a second electrochemical membrane reactor configured to remove lithium from the lithium enriched stream, the first electrochemical membrane reactor coupled to the second electrochemical membrane reactor, the second electrochemical membrane reactor comprising:
one or more working electrodes;
one or more counter electrodes;
one or more bipolar membranes; and
a power source configured to apply a voltage to the second electrochemical membrane reactor.

14. The system of claim 13, wherein the one or more working electrodes in the first electrochemical membrane reactor comprise one or more of a plate working electrode and a porous working electrode; and wherein the one or more counter electrodes in the first electrochemical membrane reactor comprise one or more of a plate counter electrode and a porous counter electrode.

15. A system comprising an electrochemical membrane reactor, the electrochemical membrane reactor comprising:
one or more counter electrodes in one or more counter electrode chambers;
one or more working electrodes in one or more working electrode chambers adjacent the one or more counter electrode chambers;
at least one ionic exchange membrane between at least one of the one or more counter electrode chambers and the one or more working electrode chambers;
an inlet for supplying a leaching solution to the one or more working electrode chambers;
a power source electrically coupled to the one or more counter electrodes and the one or more working electrodes for applying a current between the one or more counter electrodes and the one or more working electrodes;
a purging system for introducing one or more of N₂, argon, air and O₂, to the electrochemical membrane reactor;
a pH measurement system coupled to the electrochemical membrane reactor; and
an outlet for discharging a purified leaching solution.

16. A method for recovering lithium from a lithium-containing solution, comprising:
introducing a solution comprising lithium and one or more elements to a first electrochemical membrane reactor;
applying a voltage to the first electrochemical membrane reactor to ionize one or more of the one or more elements;
reducing the one or more ionized elements to form one or more reduced elements;
adjusting a pH of the solution to precipitate the one or more elements;
removing the one or more precipitated elements from the solution comprising lithium and one or more elements to form a lithium enriched stream;
introducing the lithium enriched stream to a second electrochemical membrane reactor;
suspending one or more of battery material, MnO₂, graphite, FePO₄, Li_{2-x′}TiO₃, Li_{1-x′}, NiₓMn_{y}Co_{z}O₂ in the lithium enriched stream to form a first suspension;
suspending one or more of lithiated MnO₂, graphite, FePO₄, Li₂₋ₓ TiO₃, Li_{1-x′}NiₓMn_{y}Co_{z}O₂ (x+y+z=1) particles in a LiOH solution to form a second suspension;
subjecting the first suspension and the second suspension to one or more of mechanical stirring, Vortex shaking, or ultrasound;
passing the first suspension through a working electrode chamber of the second electrochemical membrane reactor;
passing the second suspension through a counter electrode chamber of the second electrochemical membrane reactor;
applying a voltage to the second electrochemical membrane reactor to extract lithium from the first suspension forming a lithium depleted stream, releasing lithium into the second suspension forming a concentrated LiOH solution; and
recovering the lithium from the concentrated LiOH solution to form a residual stream of LiOH that is substantially free of lithium.

17. The method of claim 16, wherein reducing the one or more ionized elements to form one or more reduced elements comprises electroplating one or more of Cu, Zn, Pb, Co, Ni, Fe, Ag, Cd, Sb, and Sn on a working electrode of the first electrochemical membrane reactor; and
wherein adjusting a pH of the solution to precipitate the one or more reduced elements comprises adjusting the pH of the solution to precipitate one or more of Fe³⁺, Ga³⁺, Co²⁺, Ni²⁺, U⁴⁺, Th⁴⁺, Al³⁺, Be²⁺, Cr³⁺, Zr⁴⁺, Cd²⁺, Mg²⁺, and REEs ions and oxidize Mn²⁺ ions to MnO₂, and deposit the one or more of Fe³⁺, Ga³⁺, Co²⁺, Ni²⁺, U⁴⁺, Th⁴⁺, Al³⁺, Be²⁺, Cr³⁺, Zr⁴⁺, Cd²⁺ ions, and MnO₂ on a working electrode of the first electrochemical membrane reactor.

18. The method of claim 16, wherein removing the one or more precipitated elements from the solution to form a lithium enriched stream comprises removing one or more of uranium, thorium, silver, cadmium, aluminum, iron, manganese, copper, magnesium, lead, zinc, nickel, cobalt, chromium, zirconium, gallium, gold, platinum, and rare earth elements.

19. The method of claim 18, wherein removing the one or more of uranium, thorium, silver, cadmium, aluminum, iron, manganese, copper, magnesium, lead, zinc, nickel, cobalt, chromium, zirconium, gallium, gold, platinum, and rare earth elements comprises producing the lithium enriched stream comprising less than or equal to about 1 ppm of one or more of uranium, thorium, silver, cadmium, aluminum, iron, manganese, copper, magnesium, lead, zinc, nickel, cobalt, chromium, zirconium, gallium, gold, platinum, and rare earth elements.

20. The method of claim 16, further comprising:
introducing one or more of an NaCl solution, an HCl solution, an H₂SO₄ solution, and an Na₂SO₄ solution to the first electrochemical membrane reactor;
one or more of applying a voltage to the first electrochemical membrane reactor and adjusting a pH of the solution comprising lithium and one or more elements to form one or more of H₂SO₄, NaCl, HCl, U(OH)₄, Th(OH)₄, Ga(OH)₃, Cr(OH)₃, Al(OH)₃, Fe(OH)₃, Co(OH)₃, Ni(OH)₃, Zr(OH)₄, Cd(OH)₂, Sc(OH)₃, Y(OH)₃, lanthanides(OH)₃, Mn(OH)₂, and Mg(OH)₂; and
removing the one or more of H₂SO₄, NaCl, HCl, U(OH)₄, Th(OH)₄, Ga(OH)₃, Cr(OH)₃, Al(OH)₃, Fe(OH)₃, Co(OH)₃, Ni(OH)₃, Zr(OH)₄, Cd(OH)₂, Sc(OH)₃, Y(OH)₃, lanthanides(OH)₃, Mn(OH)₂, and Mg(OH)₂ from the solution to form the lithium enriched stream.

21. The method of claim 16, wherein one or more of Al₂O₃ and ZrO₂ forms a layer on particles of the one or more of battery material, MnO₂, graphite, FePO₄, Li₂₋ₓ TiO₃, Li_{1-x′}NiₓMn_{y}Co_{z}O₂.
